(19) United States
(12) Patent Application Publication
(10) Pub. No.: US 2024/0063749 A1
(43) Pub. Date: Feb. 22, 2024

(54) PORTABLE SOLAR POWER PLANTS AND METHODS

(71) Applicants: Khalil Badawi, Lebanon (LB); Luis Angeles Sevillano Leal, Chiclana de la Frontera (ES)

(72) Inventors: Khalil Badawi, Lebanon (LB); Luis Angeles Sevillano Leal, Chiclana de la Frontera (ES)

(21) Appl. No.: 18/270,972

(22) PCT Filed: Jan. 5, 2022
(86) PCT No.: PCT/US2022/011321

§ 371 Date: Jul. 5, 2023

Related U.S. Application Data
(60) Provisional application No. 63/134,030, filed on Jan. 5, 2021.
(60) Provisional application No. 63/134,034, filed on Jan. 5, 2021.
(60) Provisional application No. 63/134,039, filed on Jan. 5, 2021.
(60) Provisional application No. 63/134,028, filed on Jan. 5, 2021.

(51) Int. Cl. H02S 10/40; H02S 30/20

(52) U.S. Cl. CPC H02S 10/40; H02S 30/20; H02S 40/10

(57) ABSTRACT

The disclosure provides implementations of solar power plants that can be deployed in various locations.

### CROSS-REFERENCE TO RELATED APPLICATIONS

The present patent application claims the benefit of priority to U.S. Provisional Patent Application No. 63/134,028, filed Jan. 5, 2021, U.S. Provisional Patent Application No. 63/134,030, filed Jan. 5, 2021, U.S. Provisional Patent Application No. 63/134,034, filed Jan. 5, 2021, and U.S. Provisional Patent Application No. 63/134,039, filed Jan. 5, 2021. This patent application is also related to U.S. Design Application No. 29/765,035, filed Jan. 5, 2021, U.S. Design Application No. 29/765,037, filed Jan. 5, 2021, U.S. Design Application No. 29/765,040, filed Jan. 5, 2021, and U.S. Design Application No. 29/765,043, filed Jan. 5, 2021. Each of the foregoing patent applications is incorporated herein by reference for all purposes.

### BACKGROUND

### 1. Field

The disclosed embodiments relate to systems, method, and devices related to fixed and transportable structures utilizing solar technologies for generation of electricity.

### 2. Description of the Related Art

The world's ever-expanding population needs more and more electrical energy in order to power our machines, produce and distribute our products, cook our food, heat our homes, access and store our information, organize our activities, heal our ailing, care for our aged, entertain and communicate with each other and to physically transport our people from one place to another. According to the U.S. Dept. of Energy, America's 81 million buildings consume more energy than any other sector of the U.S. economy, including transportation and industry. Currently this demand for energy is dependent in great part on extracting fossil fuels from deep underground, all of which produce various levels of pollution to our air, water and environment having a negative effect upon the health of humans as well as crops, plants livestock and animals.

According to many scientists, this pollution is becoming a factor in the climate change which, in turn is anticipated to have an effect upon our food supply of fish, livestock and edible plants. However, the need for increasing amounts of energy continues to grow as we add more and more people to the world's population, and add more electronic and electrical devices designed for our comfort, survival, communication, distribution and entertainment. The presently disclosed embodiments help address some of these needs.

### SUMMARY OF THE DISCLOSURE

In accordance with some implementations, the disclosure provides implementations of a portable solar power plant. In one implementation, a portable solar power plant is provided that includes a chassis; and a plurality of arranged deployable solar panels. Each of the plurality of deployable solar panels can be slidably disposed on a respective horizontal track coupled to the chassis.

If desired, the plurality of solar panels can be disposed in a stacked horizontal configuration in an undeployed configuration. Each of the plurality of solar panels can be configured to deploy horizontally outwardly into a deployed configuration. Each solar panel in the plurality of solar panels may be configured so that it does not substantially obscure another of the solar panels in the deployed configuration from incident sunlight.

In some implementations, a cleaning function can be provided to keep the solar panels relatively free of dust. For example, a first solar panel in the plurality of solar panels can be disposed above a second solar panel in the plurality of solar panels, and the first solar panel in the plurality of solar panels can include a downwardly depending wiper extending toward an upper surface of the second solar panel in the plurality of solar panels. The wiper can wipe across and clean at least a portion of the upper surface of the second solar panel in the plurality of solar panels when the solar panels are deployed. If desired, wiper can include one or more of (i) a brush, (ii) a fabric material, and (iii) a material that electrostatically attracts dust particulate.

In further accordance with the disclosure, the portable solar power plant can further include a container including first and second side walls extending between first and second ends of the container, the first and second side walls being connected by a top wall and a bottom wall, wherein the chassis is coupled to the container. The plurality of solar panels can be disposed in a stacked horizontal configuration in an undeployed configuration inside of the container. In some embodiments, the plurality of solar panels are arranged in first and second deployable banks of solar panels, wherein the first deployable bank of solar panels can be configured to deploy outwardly along a first horizontal direction, and further wherein the second deployable bank of solar panels can be configured to deploy outwardly along a second horizontal direction opposite to the first horizontal direction. If desired, the first deployable bank of solar panels can be configured to deploy outwardly through an opening defined in the first side of the container and the second deployable bank of solar panels can be configured to deploy outwardly through an opening defined in the second side of the container. If desired, the first deployable bank of solar panels can be disposed above the second deployable bank of solar panels when the solar panels are in the undeployed configuration inside of the container. The first deployable bank of solar panels can deploy outwardly from the container at a higher elevation than the second deployable bank of solar panels. If desired, each solar panel in the first deployable bank of solar panels can be more than half of a width of the container, for example, so as to facilitate storage of the solar panels within the container when in an undeployed configuration. In some embodiments, the first and second banks of solar panels can be located upwardly from the bottom wall of the container to define a lower compartment within the container that includes circuitry for operating the portable solar power plant.

In further implementations, the portable solar power plant can further include an upper bank of solar panels disposed above the top wall of the container when the upper bank of solar panels is in a deployed configuration. In some embodiments, the upper bank of solar panels can extend beyond the first and second ends of the container when the upper bank of solar panels is in a deployed configuration. The portable solar power plant can further include a plurality of adjustable vertical supports beneath the bottom of the container to support and level the container. The portable solar power plant can further include a controller operably coupled to the solar panels. the controller can be configured to direct electrical power generated by the solar panels, among other things. For example, the controller can be operably coupled to a drive to selectively deploy and collapse the first and second deployable banks of solar panels in response to an input to the controller. If desired, the drive can be selected from (i) a hydraulic drive, (ii) a pneumatic drive, and (iii) a drive driven by an electric motor. The controller can be programmed to perform a cleaning procedure on at least some of the solar panels.

The disclosure further provides a portable solar power plant, including a portable frame; and a plurality of deployable solar panels folded about the portable frame in an undeployed stored configuration. Each of the plurality of deployable solar panels can be coupled to the portable frame by at least one hinged connection. Each of the plurality of deployable solar panels can be deployable about the at least one hinged connection from the undeployed configuration into a deployed configuration. The portable frame has a length and a width, and hinged connections about which each of the plurality of deployable solar panels deploys can be parallel to the length or the width of the portable frame.

The plurality of deployable solar panels are formed into a plurality of deployable banks of deployable solar panels. A first of the plurality of deployable banks of deployable solar panels can be collapsed around a first lateral side of the portable frame when in the undeployed configuration. A second of the plurality of deployable banks of deployable solar panels can be collapsed around a second lateral side of the portable frame when in the undeployed configuration. A third of the plurality of deployable banks of deployable solar panels can be collapsed around an upper side of the portable frame when in the undeployed configuration. In some implementations, the first, second and third deployable banks of deployable solar panels can be configured to deploy into a flat array. The flat array can be mounted on a main hinged connection with respect to the portable frame to permit the flat array to rotate from a first position to a second position about the main hinged connection. If desired, the portable solar power plant can further include a controller operably coupled to the solar panels. The controller can be configured to direct electrical power generated by the solar panels. The controller can be operably coupled to a drive to selectively position the array deploy and collapse the first and second deployable banks of solar panels in response to an input to the controller.

In further implementations, the portable frame can include a horizontally extending portion and a vertically extending portion coupled to the horizontally extending portion. If desired, the plurality of solar panels can pivotally connected to the vertically extending portion of the frame. The horizontally extending portion of the portable frame can include at least one pair of wheels to transport the portable solar power plant. The horizontally extending portion of the portable frame can include at least one coupling to attach to a tow vehicle to transport the portable solar power plant.

The disclosure further includes various implementations of a method of generating electricity. Once such method includes providing a portable solar power plant as set forth above, unfolding the plurality of deployable solar panels folded about the portable frame by pivoting the plurality of deployable solar panels about a first set of hinges to partially deploy the solar panels in a first deployment step, and further unfolding the plurality of deployable solar panels about a second set of hinges oriented orthogonally with respect to the first set of hinges to form a planar solar array in a second deployment step. At least two solar panels in the plurality of deployable solar panels can have photoactive surfaces facing each other prior to deploying the solar panels.

The disclosure further provides implementations of a portable solar power plant that includes a shipping container, electronics to operate the portable solar power plant disposed within the container, and a plurality of solar panels removably coupled to the container with fasteners, wherein the shipping container is sized to contain the plurality of solar panels and electronics to operate the portable solar power plant to permit all components of the portable solar power plant to fit inside the container to facilitate shipment prior to deploying the portable solar power plant. If desired, the portable solar power plant can further include a plurality of removable legs coupled to the shipping container. The disclosure further provides implementations of a method of providing a kit to assemble the portable solar power plant described above, wherein all components of the portable solar power plant are disposed within the shipping container. The method further includes shipping the kit to an end location, and assembling the portable solar power plant.

It is to be understood that both the foregoing general description and the following detailed description are exemplary and are intended to provide further explanation of the embodiments disclosed herein.

The accompanying drawings, which are incorporated in and constitute part of this specification, are included to illustrate and provide a further understanding of the method and system of the disclosure. Together with the description, the drawings serve to explain the principles of the disclosed embodiments.

### BRIEF DESCRIPTION OF THE DRAWINGS

The foregoing and other objects, aspects, features, and advantages of exemplary embodiments will become more apparent and may be better understood by referring to the following description taken in conjunction with the accompanying drawings, in which:

FIG. 1 depicts an isometric view of a first representative embodiment of a solar power plant in accordance with the present disclosure.

FIG. 2 depicts a top isometric view of the solar power plant of FIG. 1.

FIG. 3 depicts a view of an underside of a solar panel of the solar power plant of FIG. 1.

FIG. 4 depicts an upper view of the solar panel of FIG. 3.

FIG. 5A is an isometric top view of a plurality of deployed solar panels of the solar power plant of FIG. 1.

FIG. 5B is a further isometric top view of a plurality of deployed solar panels of the solar power plant of FIG. 1.

FIG. 5C is an isometric bottom view of a plurality of deployed solar panels of the solar power plant of FIG. 1.

FIG. 5D is an isometric bottom view of the solar power plant of FIG. 1.

FIG. 5E is an isometric bottom view of an extension panel of the solar power plant of FIG. 1.

FIG. 5F is a close up isometric bottom view of a portion of a plurality of deployed solar panels of the solar power plant of FIG. 1.

FIGS. 5G-5H illustrate a variation of the embodiment of FIG. 5F.

FIGS. 5I to 5R illustration a further implementation of a solar power plant in accordance with the present disclosure.

FIG. 6 is an isometric view of still a further embodiment of a solar power plant in accordance with the present disclosure with its solar panel array in a deployed configuration.

FIG. 7 is an isometric view of the solar power plant of FIG. 6 with its solar panel array in an un deployed configuration.

FIG. 8 is a top isometric view of the embodiment of FIG. 6.

FIG. 9 is a front view of the embodiment of FIG. 6.

FIG. 10 is a back view of the embodiment of FIG. 6.

FIG. 11 is a left elevational view of the embodiment of FIG. 6.

FIG. 12 is a right elevational view of the embodiment of FIG. 6.

FIG. 13 is a top view of the embodiment of FIG. 6.

FIG. 14 is a bottom view of the embodiment of FIG. 6.

FIG. 15 is a bottom right isometric view of the embodiment of FIG. 6.

FIG. 16 is an enlarged bottom right isometric view of the embodiment of FIG. 6.

FIG. 17 is an enlarged bottom left isometric view of the embodiment of FIG. 6.

FIG. 18 is a top left isometric view of yet a further embodiment of a portable solar panel plant in accordance with the present disclosure.

FIG. 19 is a left elevational view of the embodiment of FIG. 18.

FIG. 20 is a right elevational view of the embodiment of FIG. 18.

FIG. 21 is a front elevational view of the embodiment of FIG. 18.

FIG. 22 is a back elevational view of the embodiment of FIG. 18.

FIG. 23 is a top view of the embodiment of FIG. 18.

FIG. 24 is a bottom left rear isometric view of the embodiment of FIG. 18.

FIG. 25 is an enlarged lower isometric view of an upper solar panel of the embodiment of FIG. 18.

FIG. 26 is a data flow diagram illustrating a system for controlling a solar power plant by way of a remote or mobile device in accordance with the present disclosure.

FIG. 27 is a schematic view illustrating aspects of an exemplary system in accordance with the present disclosure.

### DETAILED DESCRIPTION

In one implementation, a portable solar power plant is provided that includes a chassis; and a plurality of arranged deployable solar panels. Each of the plurality of deployable solar panels can be slidably disposed on a respective horizontal track coupled to the chassis.

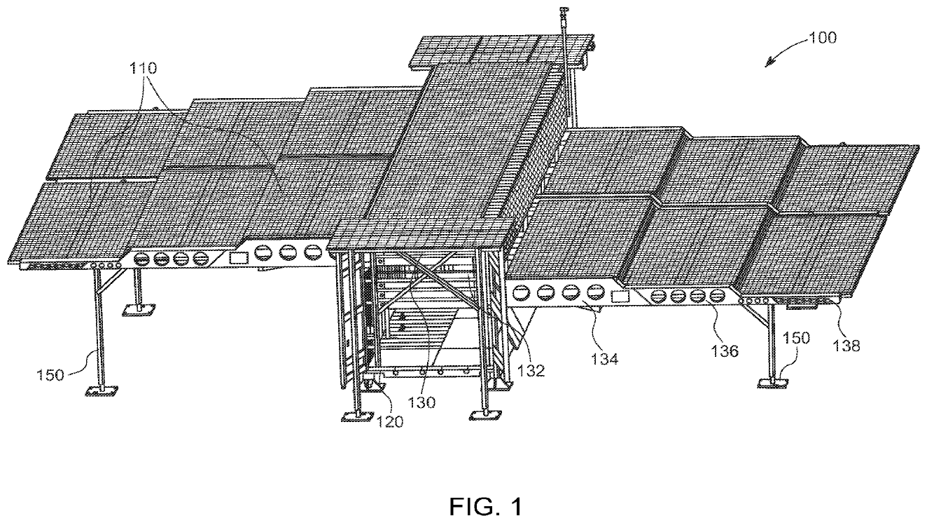

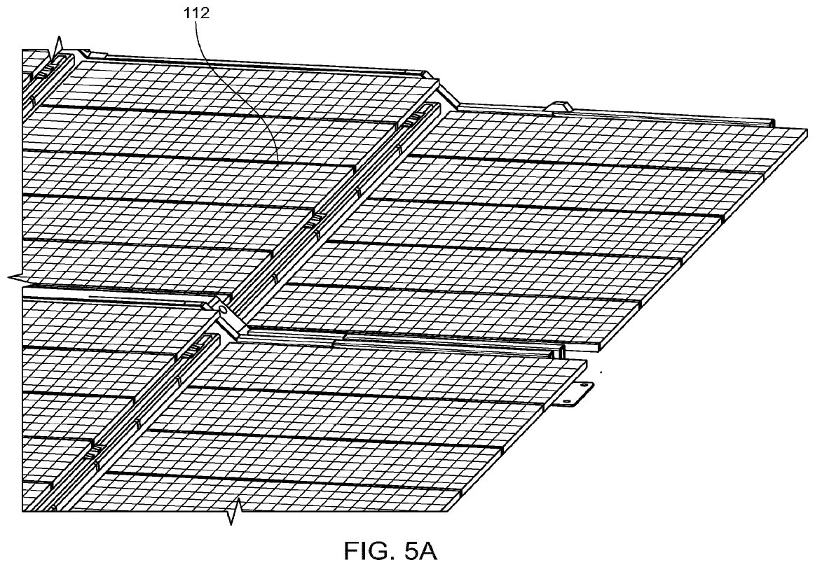

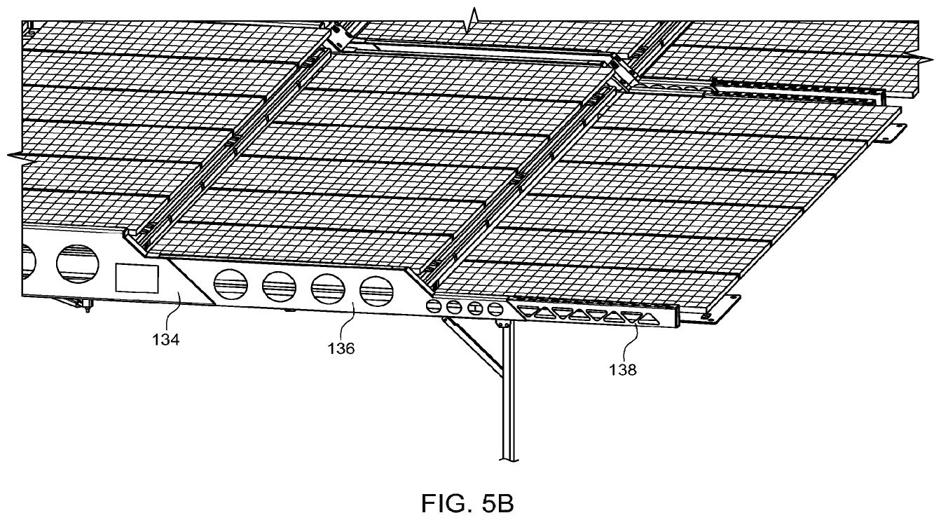

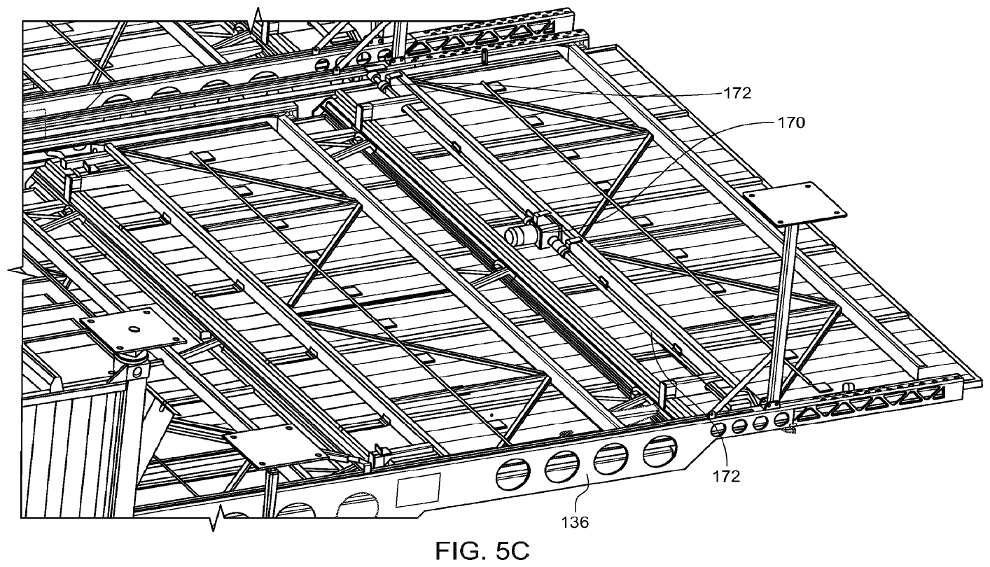

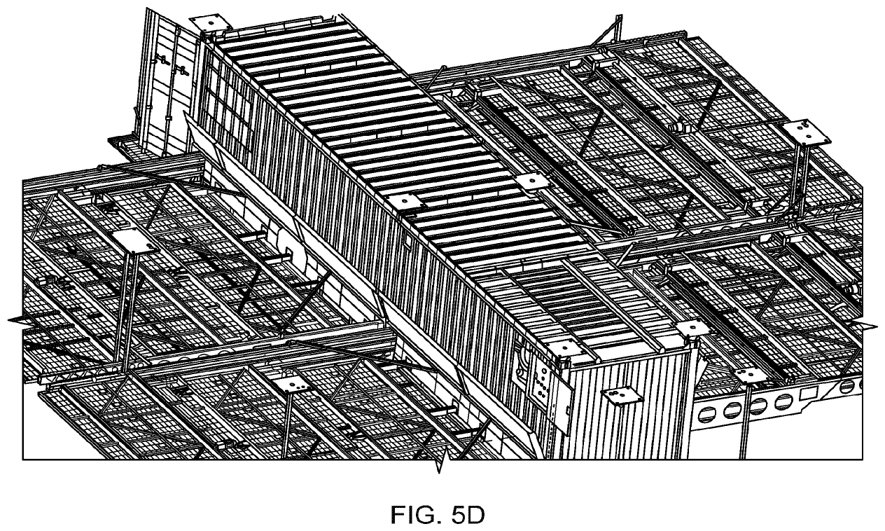

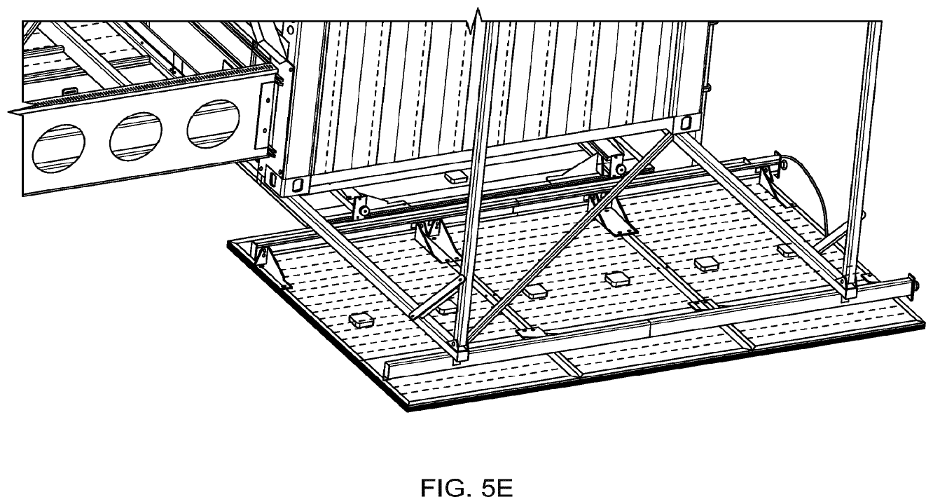

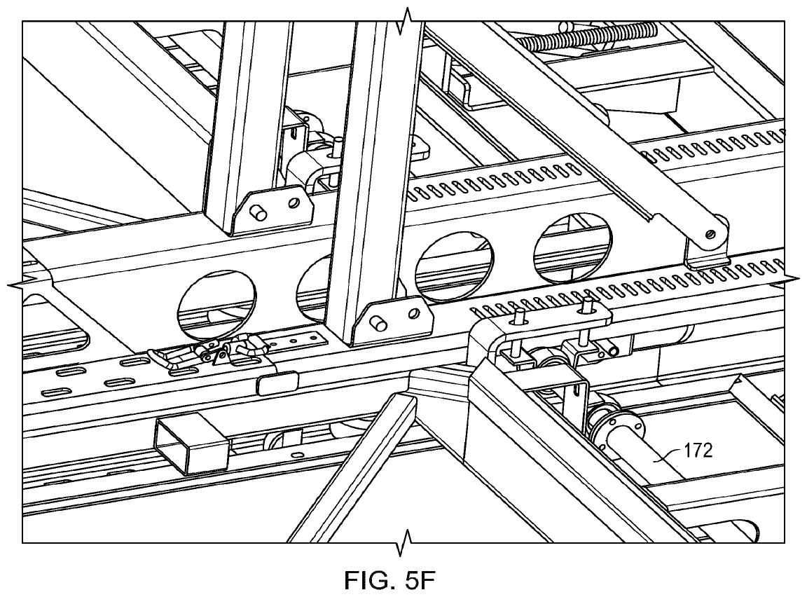

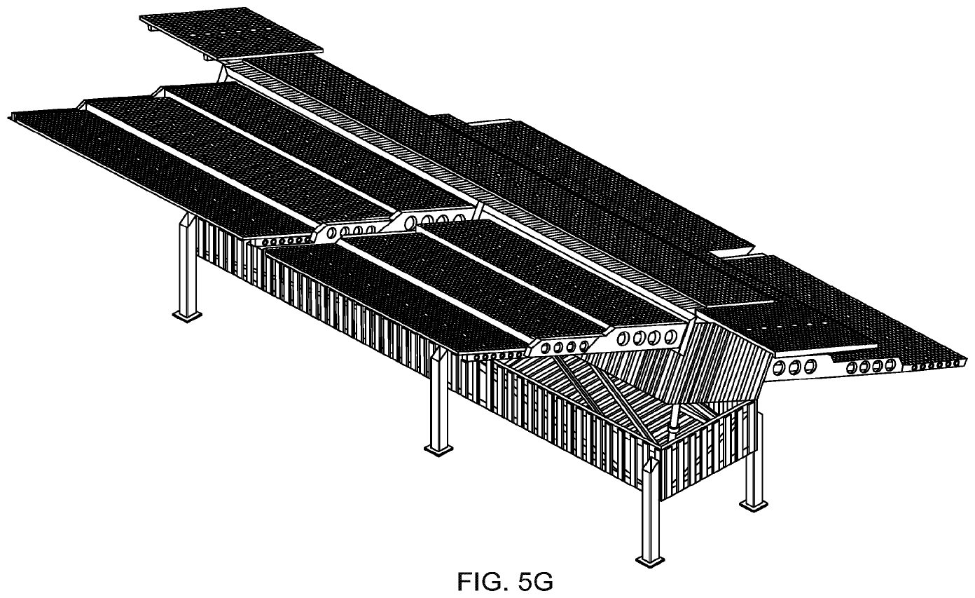

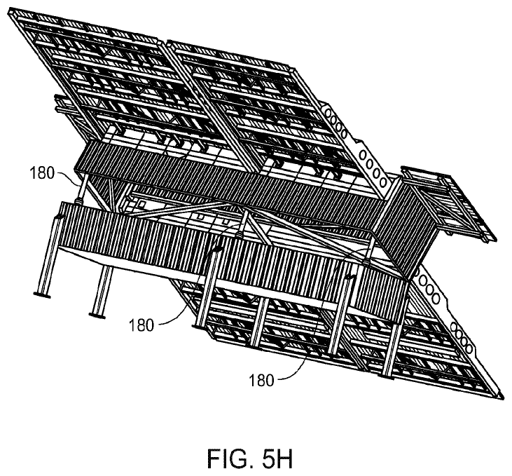

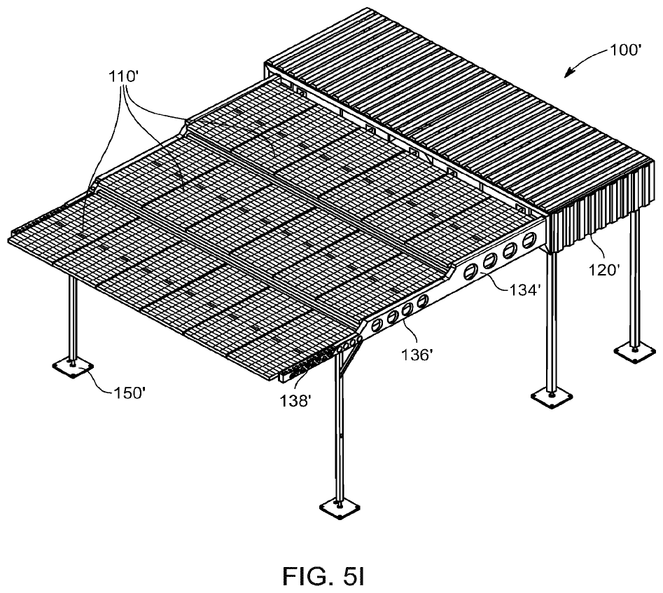

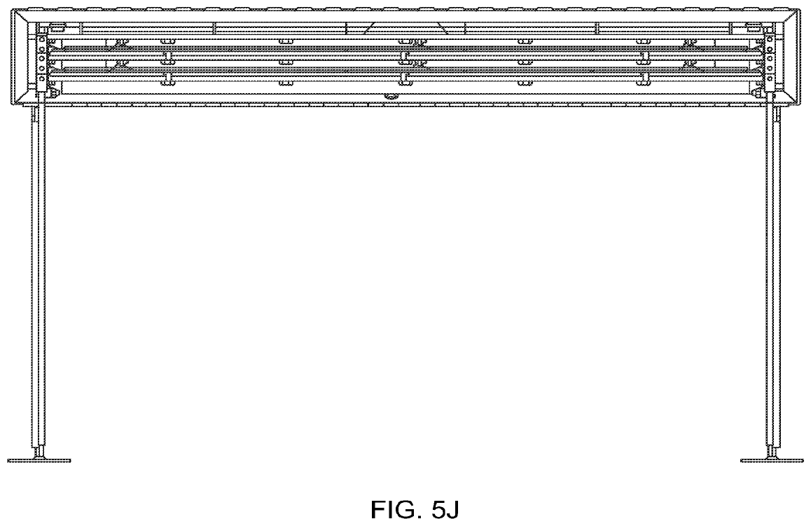

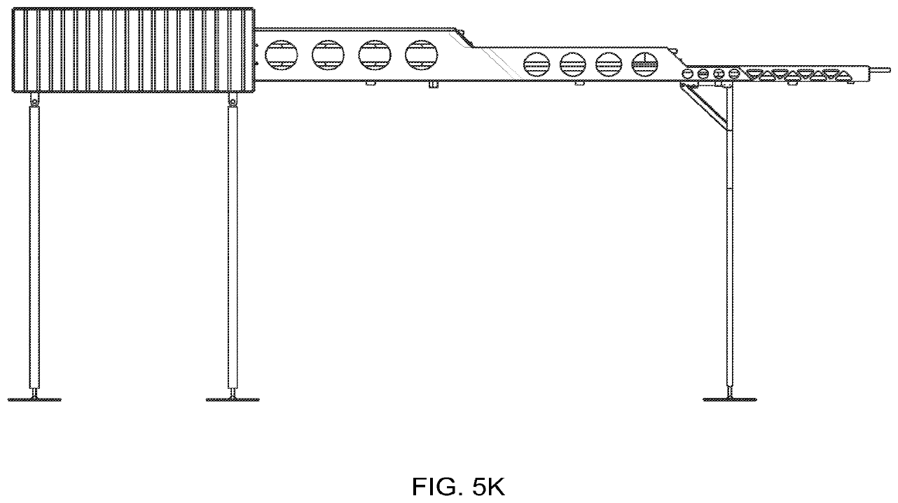

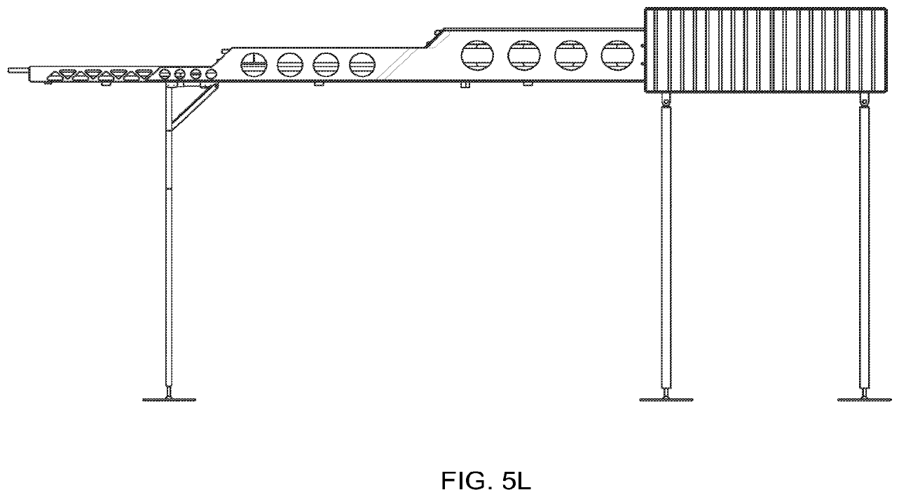

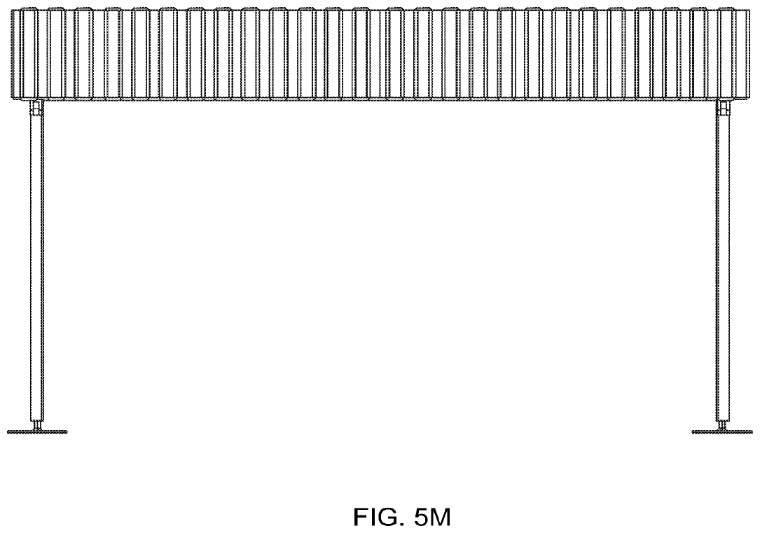

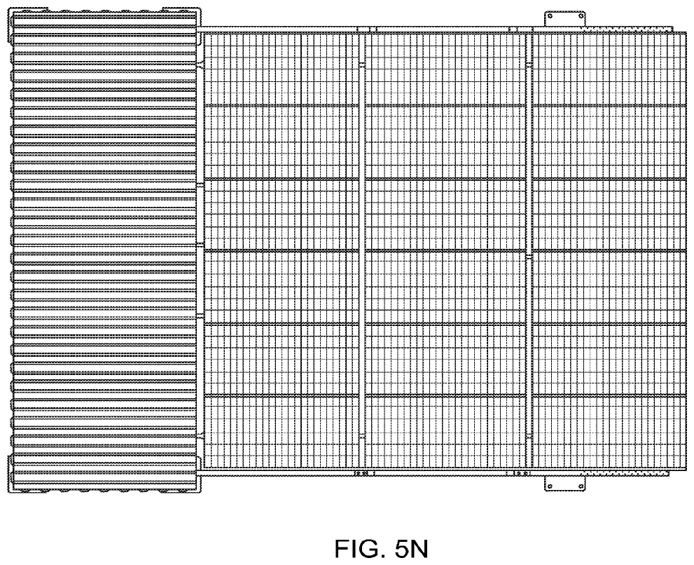

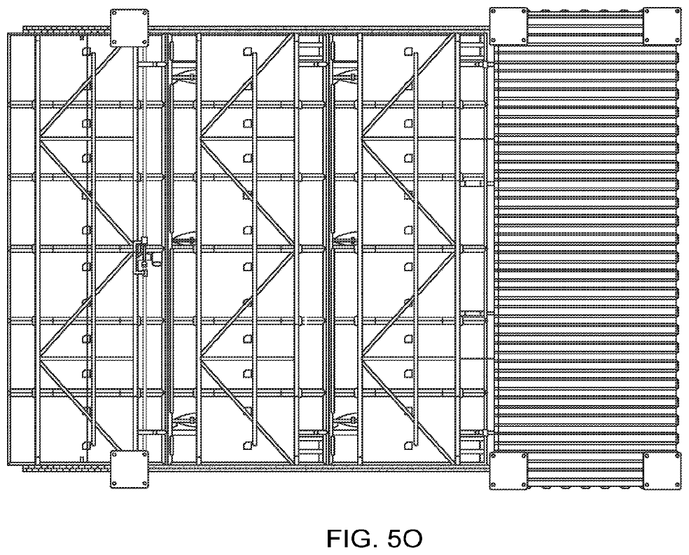

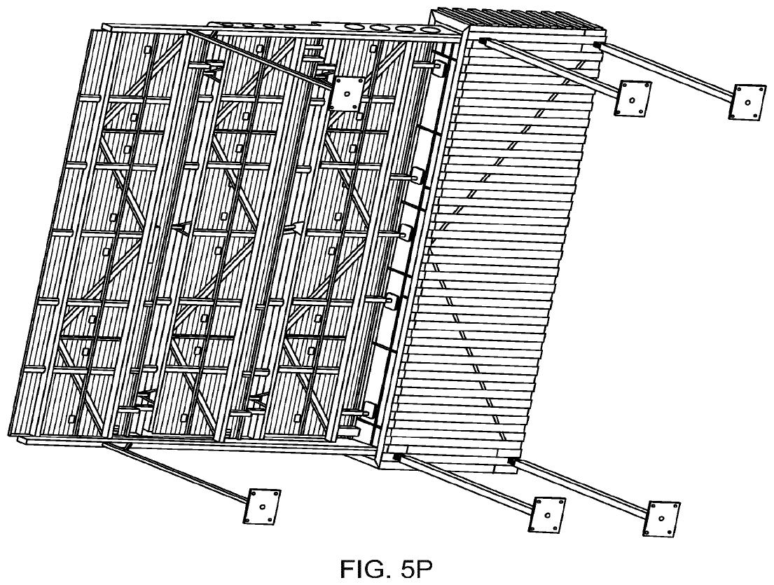

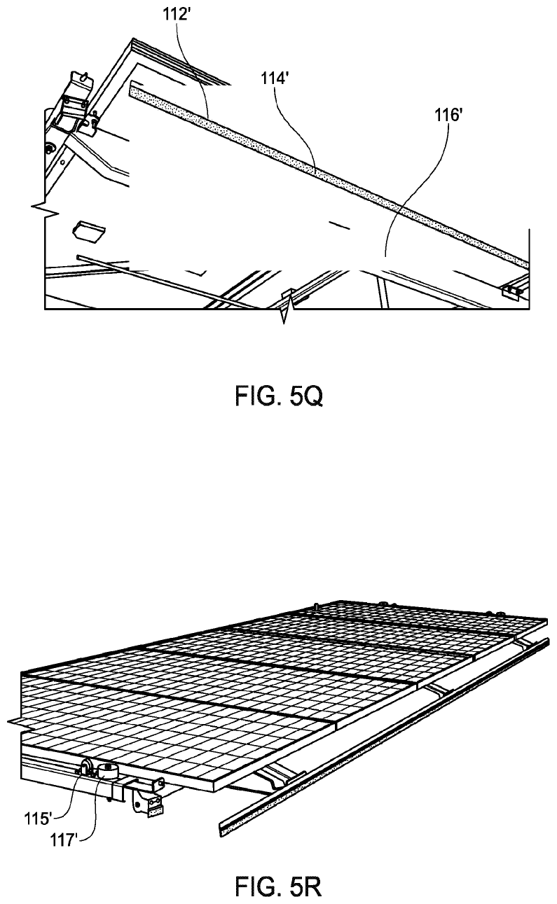

For purposes of illustration, and not limitation, as embodied herein, FIGS. 1-5 depict a first representative embodiment of a portable solar power plant in accordance with the present disclosure. As depicted, the solar power plant 100 is built on the structure of a container 120, such as a conventional shipping container of any desired length that is common in applications of transocean shipping as well as shipping across land by tractor-trailer arrangement. For example, typical exterior dimensions of these containers can include a width of eight feet, a height of eight foot, six inches, and lengths of ten, twenty or forty feet. While other configurations and sizes are possible and within the scope of the present disclosure, Applicant has come to prefer the basic structure and dimensions of standard shipping containers to facilitate transportation logistics of such systems by taking advantage of the shipping infrastructure that is in place domestically and internationally. As illustrated, the container 120 includes first and second side walls extending between first and second ends of the container 120. The first and second side walls re connected by a top wall and a bottom wall. The container can include a typical pair of access doors at one or both ends of the container, and the side walls of the container can define openings therethrough that permit the solar panel arrays to slide through. These openings can be fitted with hinged doors or removable panels (see, e.g., FIG. 5D with doors open) to seal the container during shipment. The various walls of the container (side, top, bottom) can be further provided with additional access doors (FIG. 5D) to access components disposed within the container for purposes of operating or maintaining the solar power plant 100.

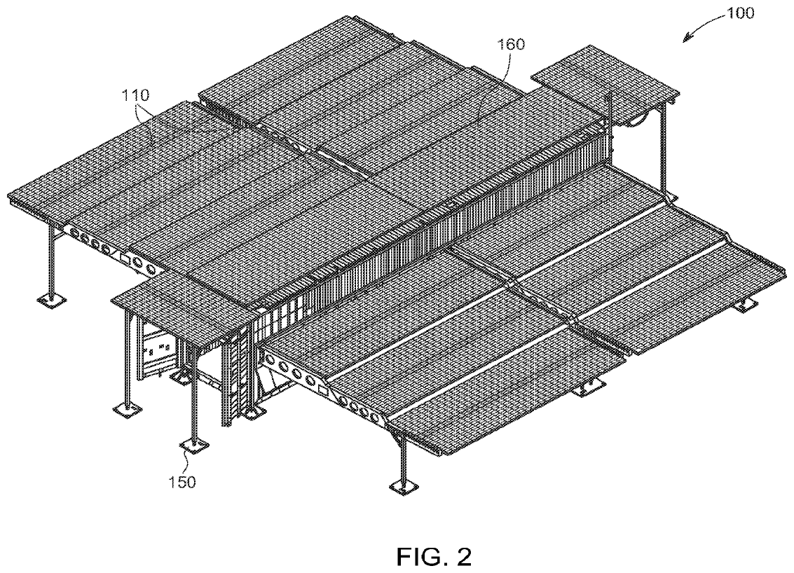

In the embodiment 100 of FIG. 1, a plurality of solar panels 110 are depicted that are disposed in a stacked horizontal configuration within the container 120 in an undeployed configuration. The solar panels are configured to deploy horizontally outwardly into a deployed configuration, as illustrated. Moreover, as depicted in FIG. 1 and FIG. 2, each solar panel in the plurality of solar panels does not substantially obscure another of the solar panels in the deployed configuration from incident sunlight. This helps to ensure that as much of the photoactive area of the panels is exposed as practicable. If desired, the panels can actually be spaced by a predetermined lateral horizontal distance from one another in the direction of deployment by configuring them accordingly.

As is visible in FIGS. 1 and 5B, a framework or chassis 132 is provided that is coupled to the housing of the container 120. The framework 132, as illustrated, includes, at each end of the container, a pair of vertical supports coupled at top and bottom near inner corners of the container. Horizontal supports are coupled to the vertical supports, each including a track or guide for supporting a drawer or sliding rail to slidably support the panels. In particular, a first rack 134 is provided that slides into the horizontal supports coupled to the vertical supports, wherein the horizontal supports are located laterally outwardly with respect to the first rack 134. The first rack 134 supports a first laterally extending set of solar panels. A second rack 136 is provided that slides within the first rack 134, wherein the horizontal supports of the first rack are located laterally outwardly (i.e., closer to the respective first and second ends of the container 120) with respect to the second rack 136. As illustrated, the second rack 136 supports a second laterally extending set of solar panels. A third rack 138 is provided that slides within the second rack 136, wherein the horizontal supports of the second rack 136 are located laterally outwardly with respect to the third rack 138. As illustrated, the third rack 138 supports a third laterally extending set of solar panels.

As illustrated, the solar panels 110 are configured to be disposed in a stacked horizontal configuration in an undeployed configuration inside of the container 120. And, as illustrated, the solar panels 110 can be arranged in first and second deployable banks of solar panels, wherein the first deployable bank of solar panels is configured to deploy outwardly along a first horizontal direction, and further wherein the second deployable bank of solar panels can be configured to deploy outwardly along a second horizontal direction opposite to the first horizontal direction. The first deployable bank of solar panels is configured to deploy outwardly through an opening defined in the first side of the container 120 and the second deployable bank of solar panels is configured to deploy outwardly through an opening defined in the second side of the container 120. As illustrated, a first deployable bank of solar panels is disposed above the second deployable bank of solar panels (including racks 134, 136, 138) when the solar panels 110 are in the undeployed configuration inside of the container 120. As such, the first deployable bank of solar panels 110 will deploy outwardly from the container 120 at a higher elevation than the second deployable bank of solar panels 110. As illustrated, each solar panel in the deployable banks of solar panels have a depth that can be more than half of a width of the container, to provide for more efficient storage of the solar panels within the container when in an undeployed configuration.

As is further illustrated in FIG. 1, the first and second banks of solar panels are located upwardly from the bottom wall of the container 120 to define a lower compartment within the container that includes circuitry and other equipment for operating the portable solar power plant 100. Preferably, the solar power plant (e.g., 100, 100′, 200, 300) is provided in a pre-wired configuration that is ready to function. This can permit for minimal setup by a handful of unskilled people for a short period of time. If desired, the panels, such as the upper panels 160 of FIG. 1 or the panels of embodiment 300 can be installed by opening the container, removing the panels from the container and installing them by sliding them into place, wherein sliding the panels into place completes the electrical connection. The sliding panel arrays of embodiment 100 can be prewired and set up to function as soon as they are deployed by sliding them out. The panels that extend beyond the end of container 120 of FIG. 1 that form part of the upper array 160 can be provided pre-wired such that they only need to be bolted onto the container 120 and plugged in. The doors and supports or legs of the powerplants can be deployed manually or automatically, as desired. As illustrated, each bank of solar panels on either side of the container 120 is actually comprised of two side by side banks of solar panels that can be actuated independently of each other.

The container 120, 220, 320 may or may not be provided with thermal insulation, but preferably include an internal compartment where certain components are stored (batteries/inverters/electronics) that are insulated and air-conditioned as well to prevent the equipment from overheating. The containers themselves can be configured to be resistant to water and dust.

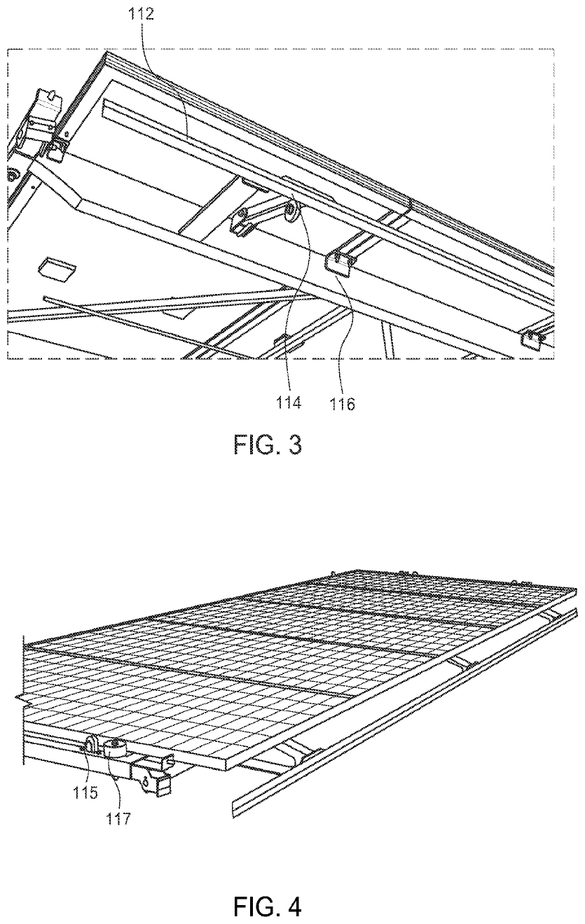

In some implementations, a cleaning function can be provided to keep the solar panels relatively free of dust. For example, as depicted in FIGS. 3 and 4, a rack (e.g., 134, 136) of a slidable bank of solar panels can be provided with a downwardly depending wiper 112 extending toward an upper surface of a second, lower solar panel in the bank of solar panels. The wiper 112 can wipe across and clean at least a portion of the upper surface of one or more solar panels situated below the wiper. In the example of embodiment 100, such a wiper can be located as illustrated at the end and lower side of racks 134 and 136 for cleaning the panels of racks 136 and 138, respectively. A further wiper similar to 112 can be disposed along a lower edge of an opening of the container 120 that wipes along the solar panels of the highest rack 134 set forth in FIG. 1. The wiper 112 can include one or more of (i) a brush, (ii) a fabric material, and (iii) a material that electrostatically attracts dust particulate, and the like. Additionally or alternatively, the wiper 112 can include a tubular plenum that includes a plurality of pneumatic jets, such as a tube pressurized with air that shoots compressed air at the solar panels disposed below the nozzles. The nozzles can be configured to jet straight downwardly, and/or at an oblique or other angle to dislodge dust, debris or moisture from the panels. If the solar panels are configured to be automatically deployed or retracted, this can similarly be done with pneumatic cylinders that are actuated by compressed air being directed through a controllable valve manifold to direct pressurized air from a reservoir pressurized by a compressor. Such a valve manifold can include output paths to one or more air jet cleaners that can be used alongside or instead of a mechanical wiper. As is further illustrated, the wiper 112 includes one or more support wheels 114 that roll along an upper surface of a lower adjacent solar panel to maintain a predetermined tolerance between the wiper 112 and the solar panel to prevent the wiper from dragging too much on the solar panel. The wipers 112 can be configured to permit a slight up and down movement to adapt to the surface of the panel below it.

FIGS. 3 and 4 further illustrate the structural frame of the rack (e.g., 134, 136, 138) that includes two lateral supports 115 at either end of the rack coined by one or more lengthwise supports 116. Guide wheels 117, stops and the like can be provided for limiting the range of motion of the rack. FIG. 5A illustrates an upper isometric view of a deployed bank of solar panels showing relative placement of the wiper 112. Additional brushes or wipers can be provided at the side of the solar arrays to clean the channel where the wheels of each rack pass to keep them clear of sand, dust and debris.

As further illustrated in FIG. 2, the portable solar power plant 100 can further include an upper bank of solar panels 160 disposed above the top wall of the container 120 when the upper bank of solar panels 160 is in a deployed configuration. As illustrated in FIGS. 2 and 5E (view from beneath extension panel), the upper bank of solar panels 160 can extend beyond the first and second ends of the container 120 when the upper bank of solar panels 160 is in a deployed configuration. While the upper bank of solar panels 160 could be configured to be deployed automatically to facilitate cleaning, in the embodiment of FIG. 2 the upper bank of solar panels 160 is configured to be installed manually. The portable solar power plant can further include a plurality of adjustable vertical supports 150 beneath the bottom of the container to support and level the container.

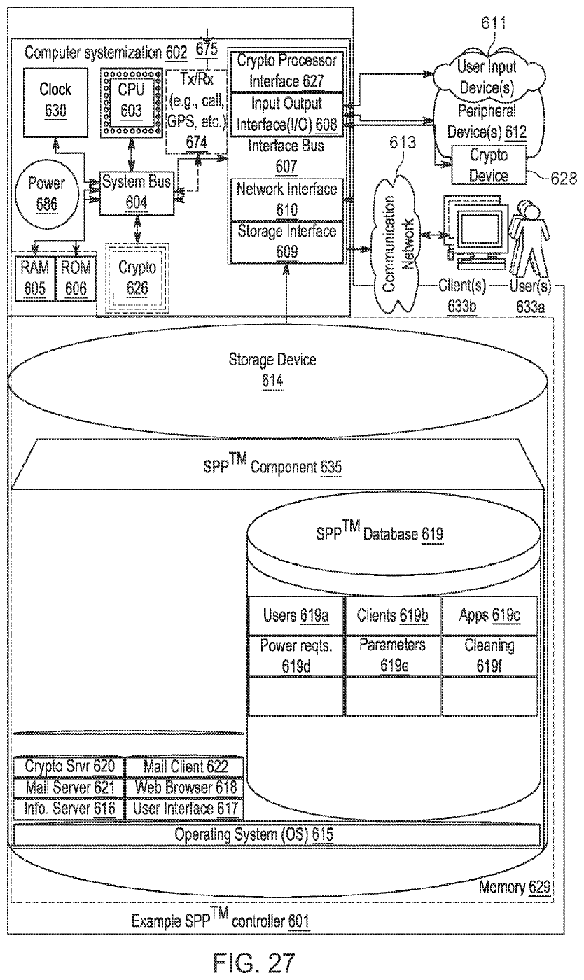

The portable solar power plant 100 can further include a controller 600 (see FIG. 27) operably coupled to the solar panels 110. The controller can be configured to direct electrical power generated by the solar panels 110, among other things. For example, the controller can be operably coupled to a drive to selectively deploy and collapse the first and second deployable banks of solar panels in response to an input to the controller. If desired, the drive can be selected from (i) a hydraulic drive, (ii) a pneumatic drive, and (iii) a drive driven by an electric motor. FIG. 5C illustrates that, in the embodiment of FIG. 1, a motor 170 is used that drives one or two drive shafts 172 that can drive a drive wheel or sprocket situated in a guide track, seen in more detail in FIG. 5F. The controller can be programmed to perform a cleaning procedure on at least some of the solar panels.

FIGS. 5G-5H illustrate an alternate embodiment of the embodiment of FIG. 5F. Specifically, the embodiment of FIGS. 5G and 5H provide the container in a clam shell configuration that can be hinged along a back side and includes jacks or actuators 180 along a front side. The actuators or jacks can be operably coupled to an electronic controller of the system as described herein to be controllably actuated to open the clamshell as depicted in FIG. 5H to control the orientation of the solar panels with respect to the sunlight. Thus, the solar array can be adjusted, for example, depending on the time of day to permit the solar panels to be better aligned with incident solar radiation. If desired, rather than hinging one edge of the container, the entire upper portion of the container can rest on actuators to permit the container to open along one or the other lengthwise side of the container to permit the container to be controllably oriented with incident solar radiation during the entire day such that a first side of the container can define a cap as in FIG. 5H in the morning. As mid-day approaches, the gap in the side of the container can shrink and close, and as the day progresses into afternoon until sunset, actuators (not shown) along the other lengthwise edge of the container can lengthen to create an open gap along the other side of the container, and keeping the first side of the container closed. Moreover, actuators at one lengthwise end of the container can be extended to create a gap at either end of the container to account for changing seasons during the course of the year to permit optimal orientation of the solar panels throughout the year.

FIGS. 5I-5R present a further embodiment of a deployable solar array in accordance with the disclosure. For purposes of illustration, and not limitation, as embodied herein, FIGS. 5I-5R depict a first representative embodiment of a portable solar power plant in accordance with the present disclosure. As depicted, the solar power plant 100′ is built on the structure of a container 120′, such as a corrugated metal container formed around a chassis or framework. As illustrated, the container 120′ includes first and second side walls extending between first and second ends of the container 120′. The first and second side walls re connected by a top wall and a bottom wall. The side wall of the container can define an opening therethrough that permits the solar panel array to slide out through. The opening can be fitted with a hinged door or removable panel, as desired, to seal the container during shipment. The various walls of the container (side, top, bottom) can be further provided with additional access doors (not shown) to access components disposed within the container for purposes of operating or maintaining the solar power plant 100′.

In the embodiment 100′ of FIG. 1, a plurality of solar panels 110′ are depicted that are disposed in a stacked horizontal configuration within the container 120′ in an undeployed configuration. The solar panels are configured to deploy horizontally outwardly into a deployed configuration, as illustrated. Moreover, as depicted in FIG. 1 and FIG. 2, each solar panel in the plurality of solar panels does not substantially obscure another of the solar panels in the deployed configuration from incident sunlight. This helps to ensure that as much of the photoactive area of the panels is exposed as practicable. If desired, the panels can actually be spaced by a predetermined lateral horizontal distance from one another in the direction of deployment by configuring them accordingly.

A framework or chassis (not shown) is provided that is coupled to the housing of the container 120′. A first rack 134′ is provided that can slides into horizontal supports coupled to the container or chassis wherein the horizontal supports are located laterally outwardly with respect to the first rack 134′. The first rack 134′ supports a first laterally extending set of solar panels. A second rack 136′ is provided that slides within the first rack 134′, wherein the horizontal supports of the first rack are located laterally outwardly (i.e., closer to the respective first and second ends of the container 120′) with respect to the second rack 136′. As illustrated, the second rack 136′ supports a second laterally extending set of solar panels. A third rack 138′ is provided that slides within the second rack 136′, wherein the horizontal supports of the second rack 136′ are located laterally outwardly with respect to the third rack 138′. As illustrated, the third rack 138′ supports a third laterally extending set of solar panels.

As illustrated, the solar panels 110′ are configured to be disposed in a stacked horizontal configuration in an undeployed configuration inside of the container 120′. And, as illustrated, the solar panels 110′ can be arranged in first and second deployable banks of solar panels, wherein the first deployable bank of solar panels is configured to deploy outwardly along a first horizontal direction. If desired a second deployable bank of solar panels (not shown) can be provided that is stacked above or below the first set of panels and configured to deploy outwardly along a second horizontal direction opposite to the first horizontal direction. The first deployable bank of solar panels is configured to deploy outwardly through an opening defined in the first side of the container 120′ and the second deployable bank of solar panels, if provided, can be configured to deploy outwardly through an opening defined in the second side of the container 120′. As illustrated, each solar panel in the deployable banks of solar panels have a depth that can be more than half of a width of the container, to provide for more efficient storage of the solar panels within the container when in an undeployed configuration.

Preferably, the solar power plant (e.g., 100′) is provided in a pre-wired configuration that is ready to function. This can permit for minimal setup by a handful of unskilled people for a short period of time. The sliding panel array of embodiment 100′ can be prewired and set up to function as soon as it is deployed by sliding them out.

The container 120′ may or may not be provided with thermal insulation, but preferably include an internal compartment where certain components are stored (batteries/inverters/electronics) that are insulated and air-conditioned as well to prevent the equipment from overheating. The containers themselves can be configured to be resistant to water and dust.

In some implementations, a cleaning function can be provided to keep the solar panels relatively free of dust. For example, as depicted in FIGS. 5Q and 5R, a rack (e.g., 134′, 136′) of a slidable bank of solar panels can be provided with a downwardly depending wiper 112′ extending toward an upper surface of a second, lower solar panel in the bank of solar panels. The wiper 112′ can wipe across and clean at least a portion of the upper surface of one or more solar panels situated below the wiper. In the example of embodiment 100′, such a wiper can be located as illustrated at the end and lower side of racks 134′ and 136′ for cleaning the panels of racks 136′ and 138′, respectively. A further wiper similar to 112′ can be disposed along a lower edge of an opening of the container 120′ that wipes along the solar panels of the highest rack 134′ set forth in FIG. 1. The wiper 112′ can include one or more of (i) a brush, (ii) a fabric material, and (iii) a material that electrostatically attracts dust particulate, and the like. Additionally or alternatively, the wiper 112′ can include a tubular plenum that includes a plurality of pneumatic jets, such as a tube pressurized with air that shoots compressed air at the solar panels disposed below the nozzles. The nozzles can be configured to jet straight downwardly, and/or at an oblique or other angle to dislodge dust, debris or moisture from the panels. If the solar panels are configured to be automatically deployed or retracted, this can similarly be done with pneumatic cylinders that are actuated by compressed air being directed through a controllable valve manifold to direct pressurized air from a reservoir pressurized by a compressor. Such a valve manifold can include output paths to one or more air jet cleaners that can be used alongside or instead of a mechanical wiper. As is further illustrated, the wiper 112′ includes one or more support wheels 114′ that roll along an upper surface of a lower adjacent solar panel to maintain a predetermined tolerance between the wiper 112′ and the solar panel to prevent the wiper from dragging too much on the solar panel. The wipers 112′ can be configured to permit a slight up and down movement to adapt to the surface of the panel below it.

FIGS. 5Q and 5R further illustrate the structural frame of the rack (e.g., 134′, 136′, 138′) that includes two lateral supports 115′ at either end of the rack coined by one or more lengthwise supports 116′. Guide wheels 117′, stops and the like can be provided for limiting the range of motion of the rack. Additional brushes or wipers can be provided at the side of the solar arrays to clean the channel where the wheels of each rack pass to keep them clear of sand, dust and debris.

The portable solar power plant 100′ can further include a controller 600 (see FIG. 27) operably coupled to the solar panels 110′. The controller can be configured to direct electrical power generated by the solar panels 110′, among other things. For example, the controller can be operably coupled to a drive to selectively deploy and collapse the first and second deployable banks of solar panels in response to an input to the controller. If desired, the drive can be selected from (i) a hydraulic drive, (ii) a pneumatic drive, and (iii) a drive driven by an electric motor.

The legs 150′ that extend downwardly from the plant 100′ can include actuators or jacks that can be operably coupled to an electronic controller of the system as described herein to level the system, and/or to adjust the orientation of the plant 100′, for example, depending on the time of day to permit the solar panels to be better aligned with incident solar radiation. The number of panels in the arrays of any of the disclosed embodiments can vary depending on the size of panel used. The embodiment of FIG. 5I can be provided, for example, with between 8 and 24 panels. The system (100′) can also include a battery system suitable for the amount of storage capacity that is needed, such as between 5 and 200 kWh, or any increment therebetween of 5 kWh. The system 100′ further includes circuitry to charge the onboard batteries and the like.

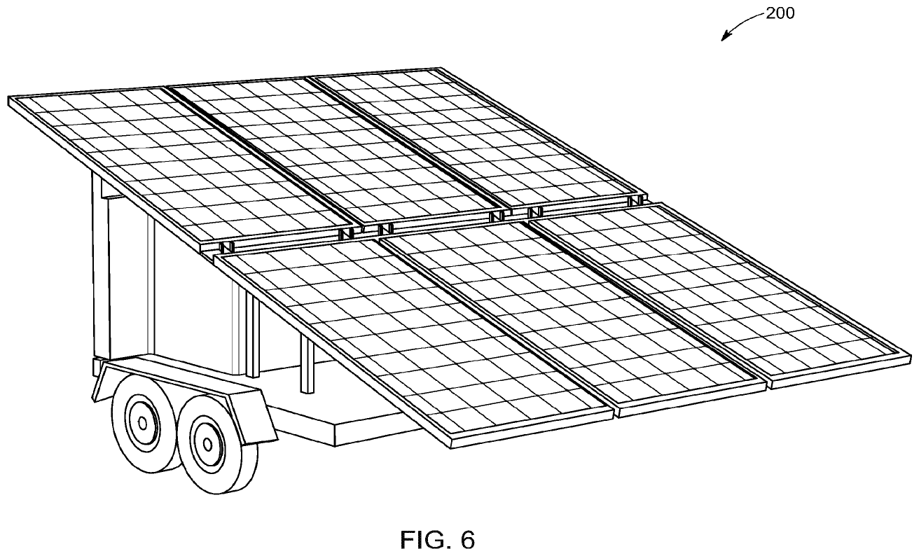

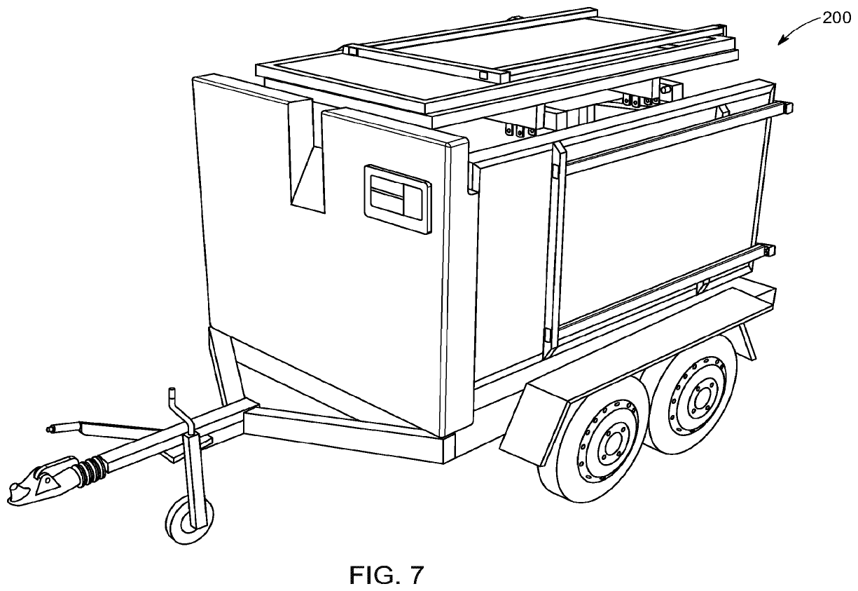

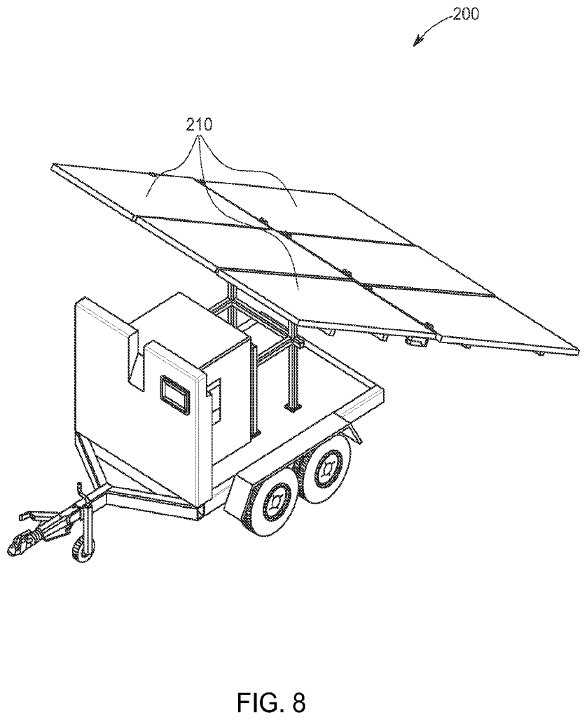

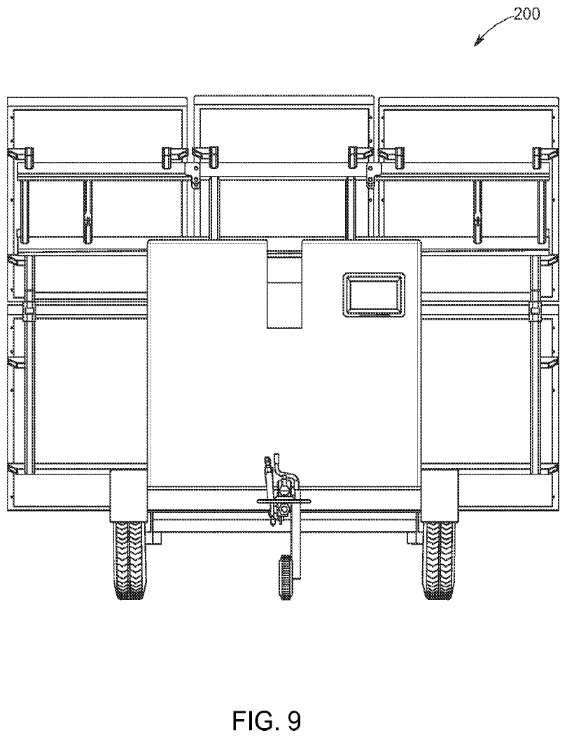

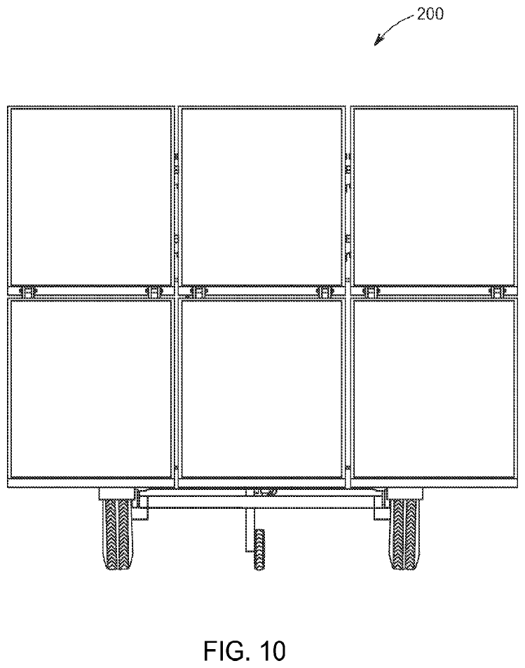

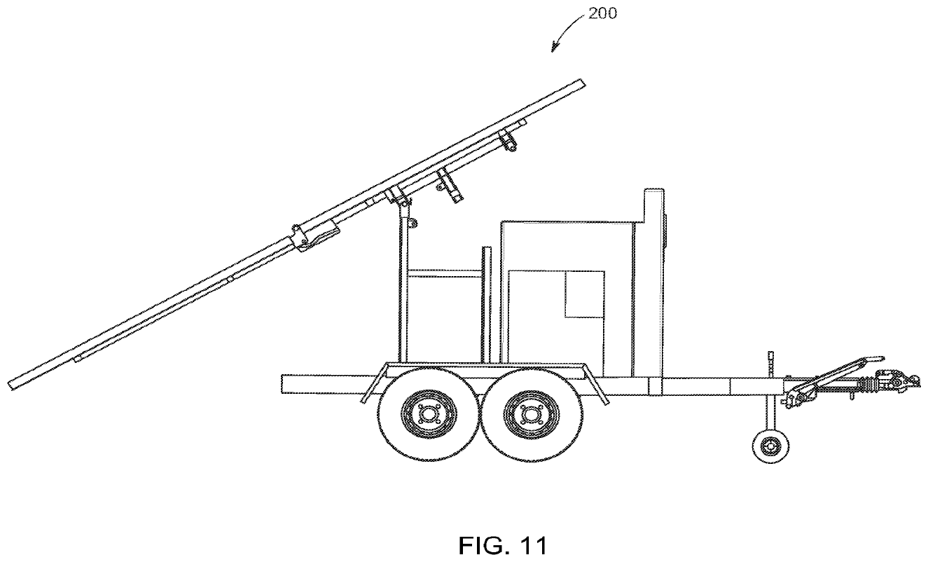

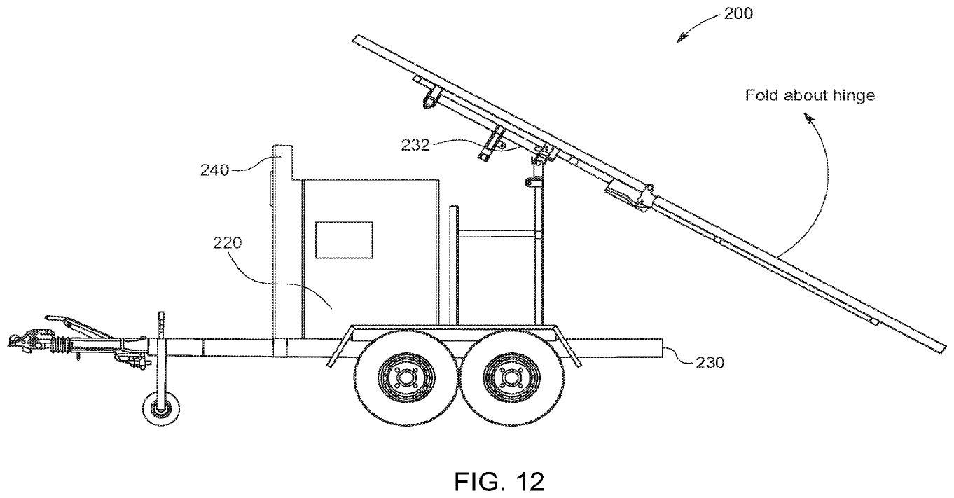

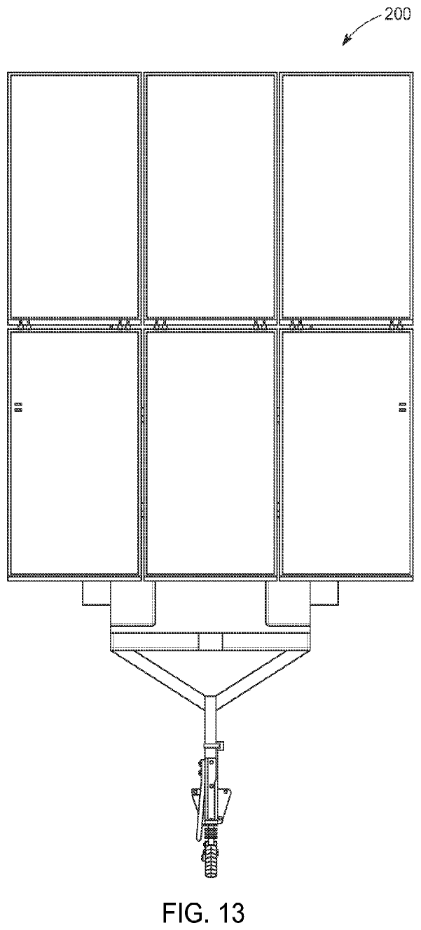

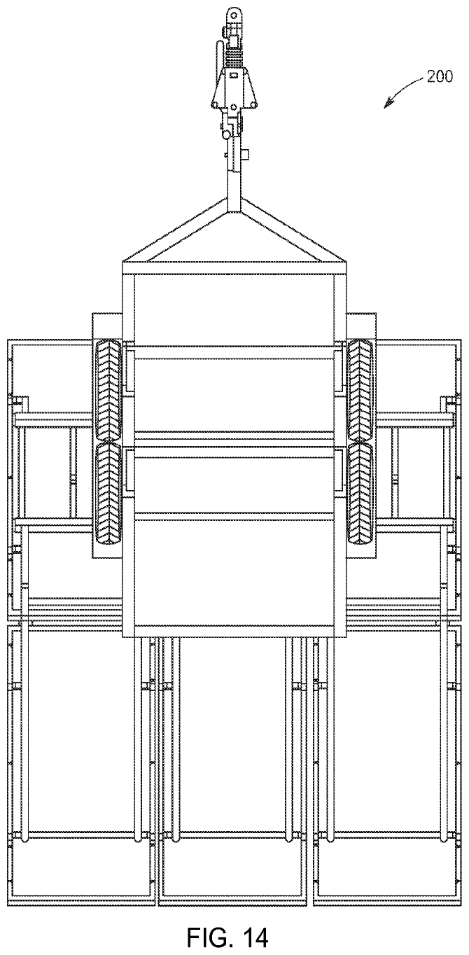

For purposes of further illustration, and not limitation, FIGS. 6-17 illustrate still a further embodiment 200 of a portable solar power plant. As depicted, embodiment 200 includes a portable frame, or chassis, mounted on a set of wheels, and includes a trailer hitch to be towed by a tow vehicle.

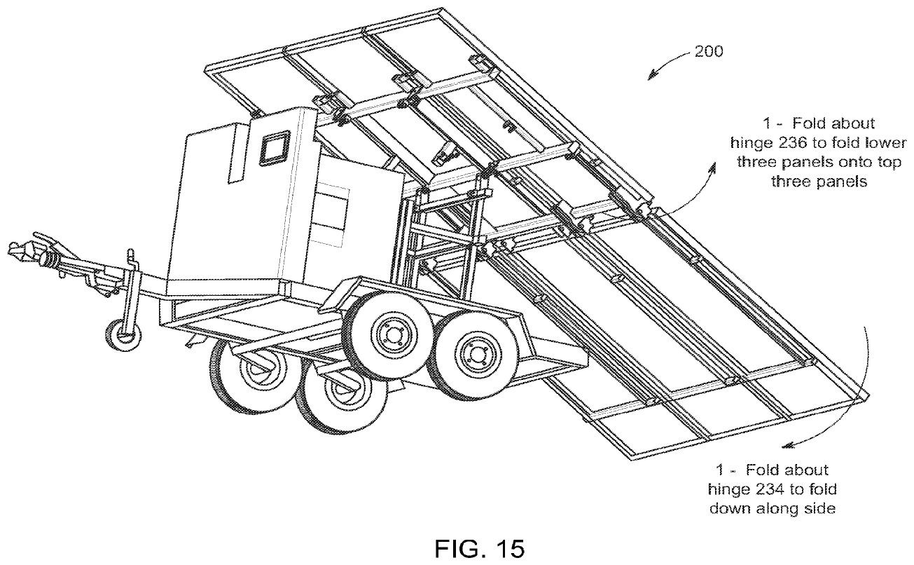

With reference to FIG. 7, plant 200 includes a plurality of deployable solar panels mounted on hinged frames that are folded about the frame of the plant 200 in an undeployed, stored configuration to facilitate transport in a manner that minimizes the likelihood of damage to the solar panels. As illustrated, an array of six solar panels is provided in upper and lower rows (FIG. 6). With reference to FIG. 15, to collapse the panels into the stored configuration, the lower row of solar panels are first folded upwardly onto the top row of three panels such that the photoactive surfaces face each other and are not exposed so as to protect them. Next, the array of panels, which is folded onto itself, is brought into a level configuration, and the side are then folded down around the frame to arrive at the illustration of FIG. 7.

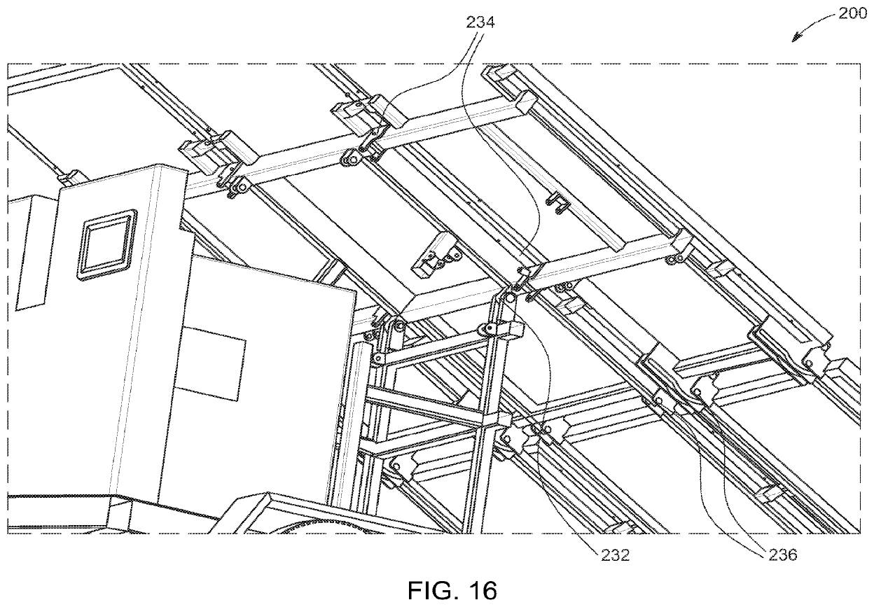

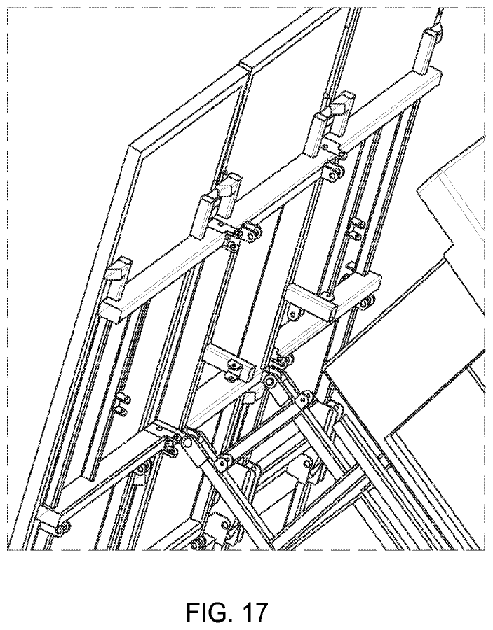

As illustrated in further detail in FIGS. 16 and 17, each of the plurality of deployable solar panels is coupled to the portable frame by at least one hinged connection, and are deployable about the at least one hinged connection from the undeployed configuration into a deployed configuration. The hinged connections about which each of the plurality of deployable solar panels deploys can be parallel to the length or the width of the portable frame, as illustrated. A vertically extending portion of the frame coupled to the horizontally extending portion. As illustrated, the plurality of solar panels is pivotally connected to the vertically extending portion of the frame at hinge point 232. As illustrated, the panels 200 are fully manually deployed by unfolding them and fixing them in position, but additional components, such as hydraulic or pneumatic cylinders can be used to deploy the panels.

As illustrated, the solar panels are formed into a three banks of panels, wherein each bank of panels includes an upper and a lower panel coupled at a hinged connection 236. A central bank is coupled by way of hinges 232 to the frame of the trailer, and each side bank is coupled to the central bank at the sides of the central panel of the upper row of panels at hinges 234. Thus, one of the banks of solar panels can be collapsed around a left side of the trailer when in the undeployed configuration. A second of the banks of deployable solar panels can be collapsed around a right side of the portable frame when in the undeployed configuration. The third, and in this illustration, central bank of deployable solar panels is collapsed around an upper side of the trailer frame when in the undeployed configuration. As illustrated, the first, second and third deployable banks of deployable solar panels are configured to deploy into a flat array. The flat array in the illustrated embodiment is mounted on main hinged connection 232. As illustrated, the plant 200 further includes an instrumentation enclosure, or container, on a front end of the trailer for housing a controller and other components (not shown) as with embodiment 100.

The container 220 may or may not be provided with thermal insulation, but preferably include an internal compartment where certain components are stored (batteries/inverters/electronics) that are insulated and air-conditioned as well to prevent the equipment from overheating. The containers themselves can be configured to be resistant to water and dust. The controller can be configured to direct electrical power generated by the solar panels, and/or be operably coupled to a drive to selectively position the array deploy and collapse the first and second deployable banks of solar panels in response to an input to the controller.

The portable solar power plant 200 can further include a controller 600 (see FIG. 27) operably coupled to the solar panels 210. The controller can be configured to direct electrical power generated by the solar panels 210, among other things. For example, the controller can be operably coupled to a drive to selectively deploy and collapse the first and second deployable banks of solar panels in response to an input to the controller. If desired, the drive can be selected from (i) a hydraulic drive, (ii) a pneumatic drive, and (iii) a drive driven by an electric motor.

The number of panels in the arrays of any of the disclosed embodiments can vary depending on the size of panel used. The embodiment 200 can be provided, for example, with between 3 and 24 panels. The system, can also include a battery system suitable for the amount of storage capacity that is needed, such as between 5 and 200 kWh, or any increment therebetween of 5 kWh. The system 200 further includes circuitry to charge the onboard batteries and the like.

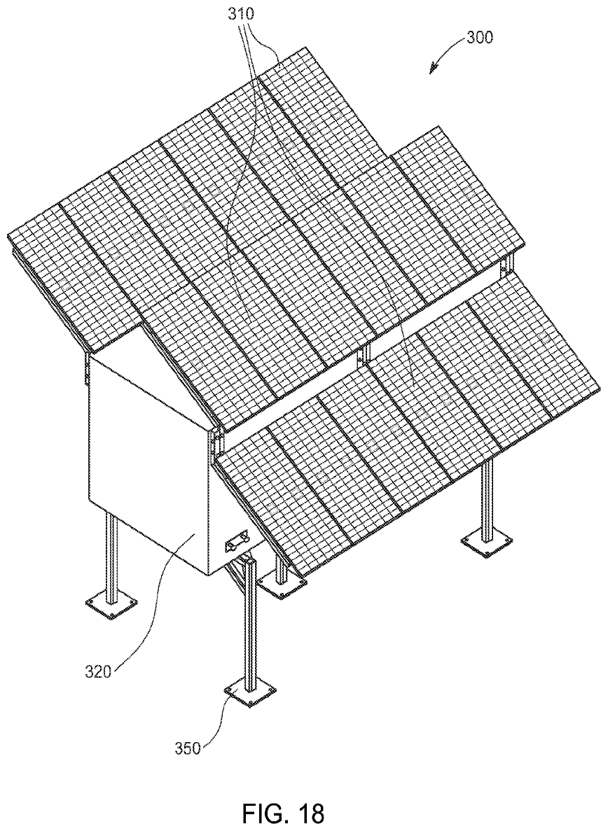

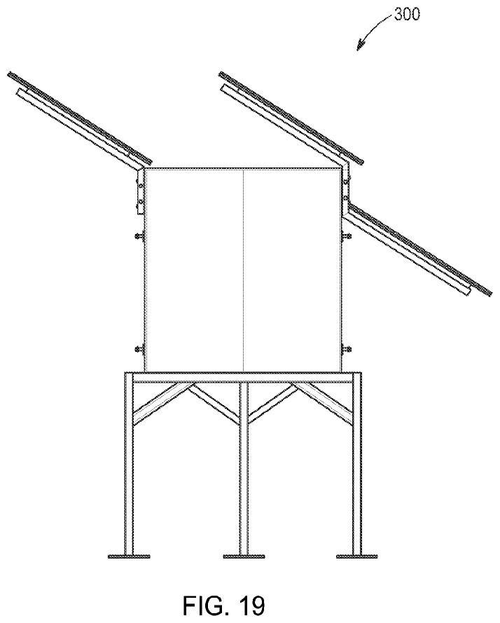

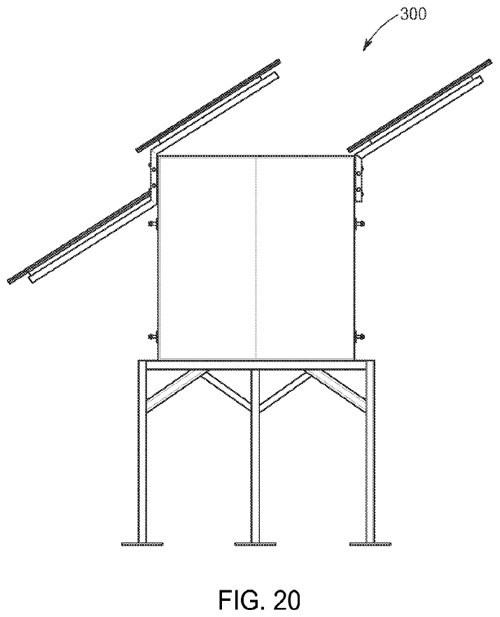

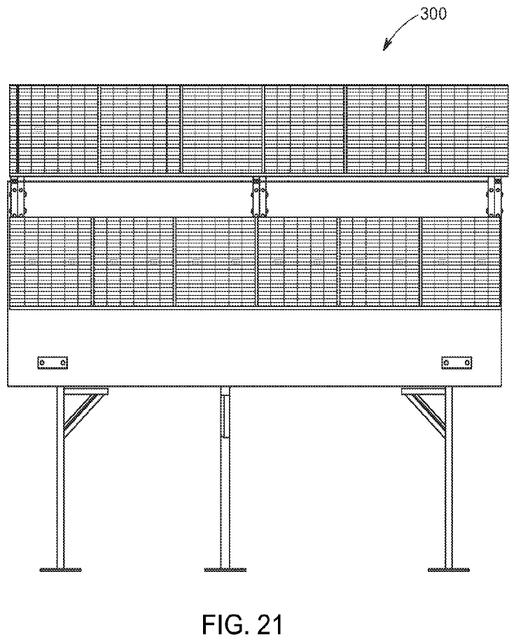

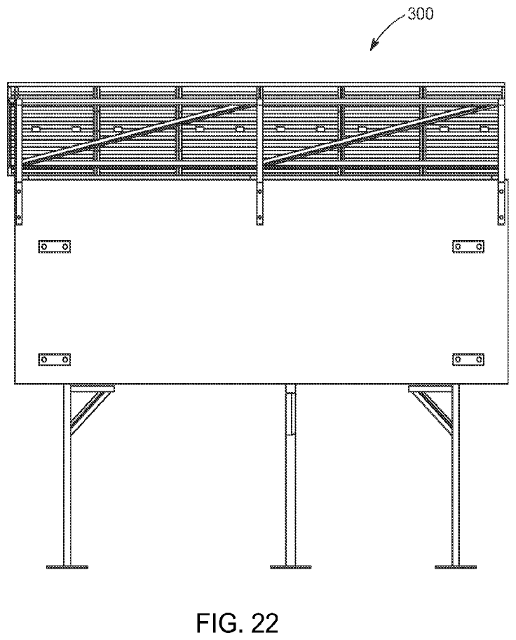

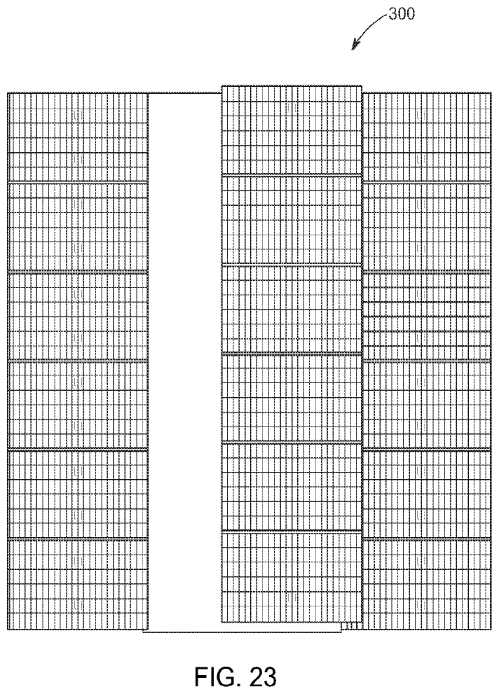

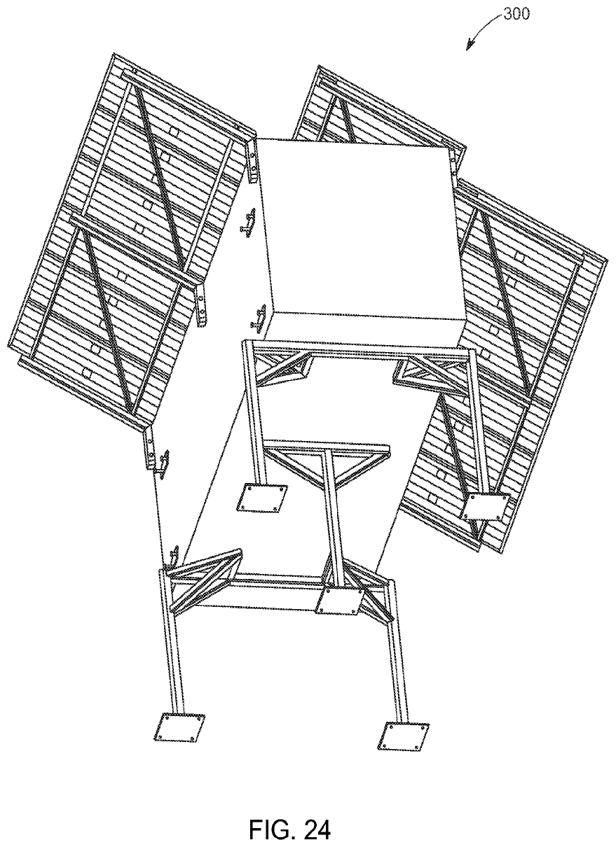

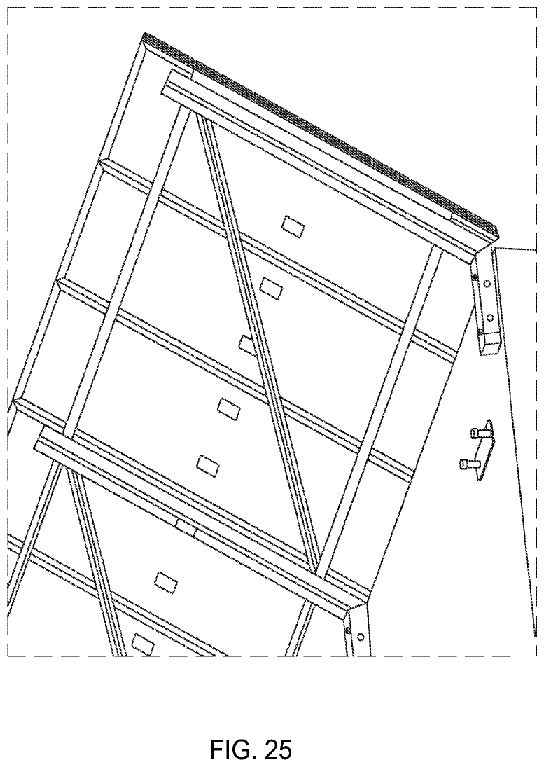

For purposes of illustration, and not limitation, as embodied herein, FIGS. 18-25 depict a first representative embodiment of a portable solar power plant 300 in accordance with the present disclosure. As depicted, the solar power plant 300 is built on the structure of a container 320, such as a conventional shipping container of any desired length (e.g, ten or twenty feet in length) that is common in applications of transocean shipping as well as shipping across land by tractor-trailer arrangement. For example, typical exterior dimensions of these containers can include a width of eight feet, a height of eight foot, six inches, and lengths of ten, twenty or forty feet. While other configurations and sizes are possible and within the scope of the present disclosure, Applicant has come to prefer the basic structure and dimensions of standard shipping containers to facilitate transportation logistics of such systems by taking advantage of the shipping infrastructure that is in place domestically and internationally. As illustrated, the container 320 includes first and second side walls extending between first and second ends of the container 320. The first and second side walls re connected by a top wall and a bottom wall. The container can include a typical pair of access doors at one or both ends of the container. The various walls of the container (side, top, bottom) can be further provided with additional access doors (not shown) to access components disposed within the container for purposes of operating or maintaining the solar power plant 300.

Portable solar power plant 300 further includes electronics to operate the portable solar power plant disposed within the container, and a plurality of solar panels removably coupled to the container with fasteners, for example. The shipping container is sized to contain the plurality of solar panels and electronics to operate the portable solar power plant to permit all components of the portable solar power plant 300 to fit inside the container to facilitate shipment prior to deploying the portable solar power plant. As illustrated, the portable solar power plant can further include a plurality of removable legs 350 coupled to the shipping container. Thus, a kit can be provided that can be used to assemble the portable solar power plant 300, wherein all components of the portable solar power plant are disposed within the shipping container.

As illustrated in FIG. 18, plant 300 includes a plurality of banks of solar panels 310 that are bolted to the container 320 by way of an intermediate framework. As illustrated, the orientation of the solar panel arrays is defined by the fixed rigid connection between the panel array and the container 320. But, the arrays can similarly be connected by a hinged connection that permits the panels to collapse, if desired, or to permit the angle of inclination of the panels to be adjusted, as desired, based on the latitude where the solar power plant 300 is located, and based on the time of year. Stepper motors, hydraulic/pneumatic actuators and the like can be used to permit remote adjustment of the panels, or to permit the panels to be collapsed against the container in the event of high winds or for any other reason.

During delivery, the plurality of solar panels 310 can be disposed in a stacked horizontal or vertical configuration within the container 320. Moreover, as depicted in FIG. 18, each solar panel in the plurality of solar panels does not substantially obscure another of the solar panels in the deployed configuration from incident sunlight. This helps to ensure that as much of the photoactive area of the panels is exposed as practicable.

The container 320 may or may not be provided with thermal insulation, but preferably include an internal compartment where certain components are stored (batteries/inverters/electronics) that are insulated and air-conditioned as well to prevent the equipment from overheating. The containers themselves can be configured to be resistant to water and dust.

In some implementations, a cleaning function can be provided to keep the solar panels relatively free of dust. For example, a plurality of pneumatic jets can be provided that direct high speed air jets over the solar panels 310 to remove dust and debris from the panels.

If desired, the solar panels 310 can be are configured to be moved about a hinge point by one or more motors or pneumatic cylinders. For example, the panels 310 can be movable so as to collapse them against the sides of the container 320 to protect them in a condition of high wind. By way of further example, the legs 350 can include mounts that are motorized disposed within the container 320 that can alter the height of the container 320 by reducing or increasing the effective length of each leg. This can be done to level the system 300, or to provide a desired alignment between the solar panels 310 and incoming radiation from the sun.

The portable solar power plant 300 can further include a controller 600 (see FIG. 27) operably coupled to the solar panels 310. The controller can be configured to direct electrical power generated by the solar panels 310, among other things. For example, the controller can be operably coupled to a drive to selectively deploy and collapse the first and second deployable banks of solar panels in response to an input to the controller. If desired, the drive can be selected from (i) a hydraulic drive, (ii) a pneumatic drive, and (iii) a drive driven by an electric motor.

The number of panels in the arrays of any of the disclosed embodiments can vary depending on the size of panel used. The embodiment of FIG. 18 can be provided, for example, with between 18 and 54 panels. The system 300 can also include a battery system suitable for the amount of storage capacity that is needed, such as between 5 and 400 kWh, or any increment therebetween of 5 kWh. The system 300 further includes circuitry to charge the onboard batteries and the like.

It should be noted that the number of panels in the arrays of any of the disclosed embodiments can vary depending on the size of panel used. The embodiment of FIG. 1 can be provided, for example, with between 70 and 90 panels. The system (100, 100′, 200, 300) also includes a battery system suitable for the amount of storage capacity that is needed, such as between 5 and 500 kWh, or any increment therebetween of 5 kWh. The system 100, 100′, 200, 300 further includes circuitry to charge the onboard batteries and the like.

If desired, the power plant (e.g., 100, 100′, 200, 300) can be provided with security systems, alarms and the like. The controller 600 can be configured to forward an alarm to an end user that can take actions to shut down the plant. Alternatively, the power plant can be configured to turn itself off if certain conditions are satisfied. The system can be user configurable to transmit selected alarms to control personnel as desired.

It will be appreciated that the disclosed power plants can be provided in various sizes, designs and variations that are adaptable to different industries and restrictions. For example, while generally horizontal panel deployments are illustrated, the disclosure also contemplates systems that deploy panels in a generally vertical orientation for applications where land space availability is an issue. This can be the case for telecom tower applications.

It will be further appreciated that multiple power plants (e.g., 100, 100′, 200, 300) can be connected together and used as a larger power source. For example, a system can be deployed where only one of the containers includes batteries, and the other containers include solar panels without batteries, permitting all of the containers to be connected into a larger power source.

Power output for the disclosed solar power plants (e.g., 100, 100′, 200, 300) is proportional to the size and number of solar panels in the plant, weather conditions and time of day. The embodiment of FIG. 1 can product as much as 30 kW of AC power, which can be adjusted to the needs of the particular application. The power production capacity combined with the onboard storage to provide for a steady amount of power that can be provided. For example, the 24 hour capacity of a 30 kW plant that operates for 4 to 5 hours per day at peak operation would need to be considered to be as low as 5 kW AC if the draw is around the clock.

The disclosed embodiments are preferably modular, permitting different components to be substituted in the plants 100, 100′, 200, 300 for different applications, as desired. Different types of batteries can be used depending on the surrounding environment, such as acid, gel, opzv, lithium ion or other battery systems. Likewise, if desired, for certain applications a regenerative fuel cell can be used that splits water into hydrogen and oxygen during periods of peak power, and then recombines them to generate electricity at night hours. If desired, a backup generator (not shown) can also be provided to charge the batteries of the system if needed to facilitate a system startup. The container can work in both online and offline modes. In offline mode, the operational parameters for the plant are preset and the plant will operate as programmed. Parameter modification can be accomplished locally. Alternatively, the plant can be connected online, preferably continuously, or intermittently, to monitor the plant remotely change any needed parameter wirelessly by way of cellular network or Wi-Fi, as desired.

If desired, the power plant can further be provided with hardware for mobile communication networks (e.g, 4G, 5G, etc.) to serve as a communication node. Additional functionalities can be added, as desired, such as a water filtration and sanitizing system to provide drinking water, and the like, as well as communication systems that can be viewed locally for end users to monitor electronic communications, and the like. It will be further appreciated that the disclosed power plants can be coupled to power management systems and electrical grids that utilize other kinds of power sources such as wind turbines and the like.

Exemplary Computer Controlled Solar Power Plant (SPP) Systemization

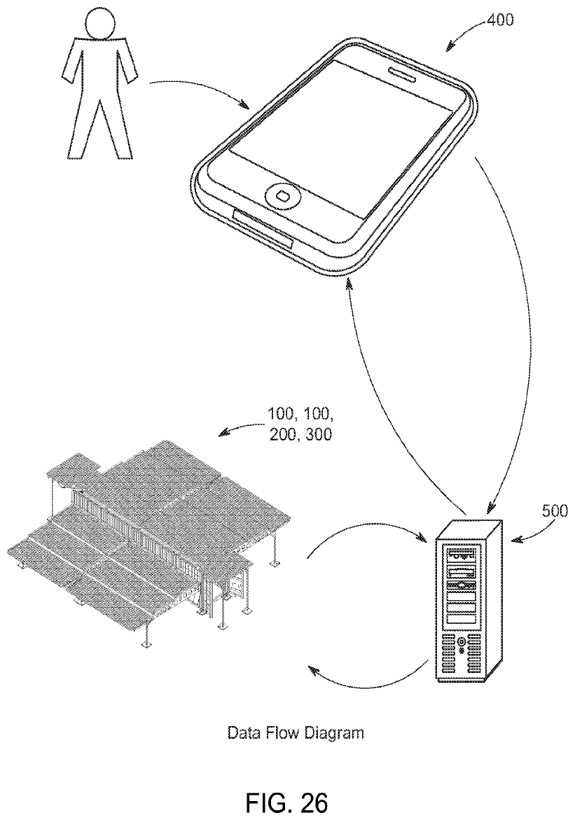

An exemplary control system is depicted in FIG. 26 for operating a solar power plant (e.g., 100, 100′, 200, 300) as described herein. If desired, the solar power plant can be operated, monitored and controlled remotely via a mobile device 400, such as a smart phone or remote computer terminal via a server 500. Instructions can be input by a user via the remote/mobile device via a server that is in communication with a controller onboard the solar power plant to operate the solar power plant in any desired manner, such as via wireless network and the like, as described below. The controller can be configured to operate as an energy management system to manage the generation, storage and distribution of energy.

### Example—SPP™ Controller

FIG. 27 illustrates inventive aspects of a Solar Power Plant (“SPP”™) controller 601 for controlling a system such as that illustrated in FIG. 26 implementing some of the embodiments disclosed herein. In this embodiment, the SPP™ controller 601 may serve to aggregate, process, store, search, serve, identify, instruct, generate, match, and/or facilitate interactions with a computer through various technologies, and/or other related data.

One possible controller for controlling and monitoring the system of the solar power plant can be the Venus GX system from Victron Energy. This illustrative system permits communication with all components of the solar power plant and ensure that the components are working properly, and permits the monitoring of live data, and changing of settings using a remote terminal, or mobile electronic device by way of a web portal. Various parameters can be monitored, such as battery state of charge; present power consumption; power harvest from the solar panels, power provision from mains/generator, and the like. The controller can be programmed to auto-start an onboard generator if provided, in response to low-voltage; high-demand; or battery state of charge, for example. The system can similarly be configured to delay ignition until the end of periods where loud machinery should not be run.

Typically, a user or users, e.g., 633a, which may be people or groups of users and/or other systems, may engage information technology systems (e.g., computers) to facilitate operation of the system and information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the SPP™ controller 601 may be connected to and/or communicate with entities such as, but not limited to: one or more users from user input devices 611; peripheral devices 612, components of the solar power plant (e.g., 100, 100′, 200, 300); an optional cryptographic processor device 628; and/or a communications network 613. For example, the SPP™ controller 601 may be connected to and/or communicate with users, e.g., 633a, operating client device(s), e.g., 633b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The SPP™ controller 601 may be based on computer systems that may comprise, but are not limited to, components such as: a computer systemization 602 connected to memory 629. The controller can function as an energy storage system (ESS) that is a specific type of power system that integrates a power grid connection with an inverter/charger, system monitor controller device and battery system. It stores solar energy into your battery during the day, for use later on when the sun stops shining. It allows for time shifting power, charging from solar, providing grid support, and exporting power back to the grid. When an ESS system is able to produce more power than it can use and store, it can sell the surplus to the grid; and when it has insufficient energy or power, it automatically buys it from the grid. When there is more PV power than is required to run loads, the excess PV energy can be stored in the battery. That stored energy can then be used to power the loads at times when there is a shortage of PV power. The percentage of battery capacity used for self-consumption can be configurable. When utility grid failure is extremely rare it can be set to 100%. In locations where grid failure is common—or even a daily occurrence, the system can be configured accordingly. The controller can also be configured to keep the batteries fully charged. Utility grid failure is then the only time battery power is used—as a backup. Once the grid is restored, the batteries will be recharged either from the grid or from solar panels when they are available. The controller is further coupled to an onboard inverter, battery monitors, and other system components, as appropriate.

Computer Systemization

A computer systemization 602 for controlling the solar power plant (e.g., 100, 100′, 200, 300) may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effect communications, operations, storage, etc. Optionally, the computer systemization may be connected to an internal power source 686; e.g., optionally the power source may be internal. Optionally, a cryptographic processor 626 and/or transceivers (e.g., ICs) 674 may be connected to the system bus. In another embodiment, the cryptographic processor and/or transceivers may be connected as either internal and/or external peripheral devices 612 via the interface bus I/O. In turn, the transceivers may be connected to antenna(s) 675, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing SPP™ controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 629 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the SPP™ controller and beyond through various interfaces. Should processing requirements dictate a greater amount speed and/or capacity, distributed processors (e.g., Distributed SPP™ embodiments), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the SPP™ implementations may be achieved by implementing a microcontroller such as CAST's R8051XC2 microcontroller; Intel's MCS 51 (i.e., 8051 microcontroller); and/or the like. Also, to implement certain features of the SPP™ embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the SPP™ component collection (distributed or otherwise) and/or features may be implemented via the microprocessor and/or via embedded components; e.g., via ASIC, coprocessor, DSP, FPGA, and/or the like. Alternately, some implementations of the SPP™ may be implemented with embedded components that are configured and used to achieve a variety of features or signal processing.

Depending on the particular implementation, the embedded components may include software solutions, hardware solutions, and/or some combination of both hardware/software solutions. For example, SPP™ features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the SPPim features. A hierarchy of programmable interconnects allow logic blocks to be interconnected as needed by the SPPim system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the SPPim may be developed on regular FPGAs and then migrated into a fixed version that more resembles ASIC implementations. Alternate or coordinating implementations may migrate SPP-rm controller features to a final ASIC instead of or in addition to FPGAs. Depending on the implementation all of the aforementioned embedded components and microprocessors may be considered the “CPU” and/or “processor” for the SPP m.

Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the SPP™ thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the SPP™ controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed SPPim), architectures may similarly be employed to pool, load balance, and/or otherwise increase the communicative bandwidth required by the SPP™ controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 611 often are a type of peripheral device 612 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 612, such as other components of the solar power plant, including temperature sensors, air compressors, drive systems, cooling systems (if provided) and the like may be connected and/or communicate to I/O and/or other facilities of the like such as network interfaces, storage interfaces, directly to the interface bus, system bus, the CPU, and/or the like. Peripheral devices may be external, internal and/or part of the SPP™ controller. Peripheral devices may also include, for example, an antenna, audio devices (e.g., line-in, line-out, microphone input, speakers, etc.), cameras (e.g., still, video, webcam, etc.), drive motors, cooling systems, lighting, video monitors, anemometers, humidity and other weather parameter sensors and/or the like.

Cryptographic units such as, but not limited to, microcontrollers, processors 626, interfaces 627, and/or devices 628 may be attached, and/or communicate with the SPP™ controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory 629 (or 68, 72, etc.). However, memory is a fungible technology and resource, thus, any number of memory embodiments may be employed in lieu of or in concert with one another. It is to be understood that the SPP™ controller and/or a computer systemization may employ various forms of memory 629. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory 629 may contain a collection of program and/or database components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server component(s) 620 (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

Operating System

The operating system component 615 is an executable program component facilitating the operation of the SPP™ controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NTNista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the SPP™ controller to communicate with other entities through a communications network 613. Various communication protocols may be used by the SPP™ controller as a subcarrier transport mechanism for interaction, such as, but not limited to: multicast, TCP/IP, UDP, unicast, and/or the like.

Information Server

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C #and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the SPPim controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the SPP™ database 619, operating systems, other program components, user interfaces, Web browsers, and/or the like.

Access to the SPP™ database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the SPP™. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the SPP™ as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XPNista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the SPP™ enabled nodes. The combined application may be nugatory on systems employing standard Web browsers.

Mail Server

A mail server component 621 is a stored program component that is executed by a CPU 603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C #and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the SPP™.

Access to the SPP™ mail may be achieved through a number of APIs offered by the individual Web server components and/or the operating system.

Also, a mail server may contain, communicate, generate, obtain, and/or provide program component, system, user, and/or data communications, requests, information, and/or responses.

Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the SPP™ may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for a digital audio file. A cryptographic component may communicate to and/or with other components in a component collection, including itself, and/or facilities of the like. The cryptographic component supports encryption schemes allowing for the secure transmission of information across a communications network to enable the SPP™ component to engage in secure transactions if so desired. The cryptographic component facilitates the secure accessing of resources on the SPP™ and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

The SPP™ Database

The SPP™ database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the SPP™ database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the SPP™ database is implemented as a data-structure, the use of the SPP™ database 619 may be integrated into another component such as the SPP™ component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-n. A Users (e.g., operators and technicians) table 619a may include fields such as, but not limited to: user_id, ssn, dob, first_name, last_name, age, state, address_firstline, address_secondline, zipcode, devices list, contact info, contact type, alt contact info, alt contact type, and/or the like to refer to any type of enterable data or selections discussed herein. The Users table may support and/or track multiple entity accounts. A Clients table 619b may include fields such as, but not limited to: user_id, client_id, client_ip, client_type, client_model, operating_system, os_version, app_installed_flag, and/or the like. An Apps table 619c may include fields such as, but not limited to: app_ID, app_name, app_type, OS_compatibilities_list, version, timestamp, developer_ID, and/or the like. A solar power plant control table 619d including, for example, sunrise and sunset times based on latitude and longitude and other useful parameters for solar power generation, such as depending on time_of_day, panel_output_voltage, panel_output_current, electrical_load, equipment_enclosure_temperature, number_of_solar_panels, and/or the like. An Parameter table 619e may include fields including the foregoing fields, or additional ones such as equipment_cool_start_time, cool_preset, cooling_rate, and/or the like. A Cleaning Routines table 619f may include a plurality of cleaning sequences may include fields such as, but not limited to: sequence_type, sequence_id, air_flow_rate, avg_air_temp, wiper_speed, pump_setting, pump_speed, pump_pressure, power_level, temperature_sensor_id_number, temperature_sensor_location, and/or the like.

In one embodiment, user programs may contain various user interface primitives, which may serve to update the SPP™ platform. Also, various accounts may require custom database tables depending upon the environments and the types of clients the SPP-rm system may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-n. The SPP™ system may be configured to keep track of various settings, inputs, and parameters via database controllers.

The SPP™ database may communicate to and/or with other components in a component collection, including itself, and/or facilities of the like. Most frequently, the SPP™ database communicates with the SPP™ component, other program components, and/or the like. The database may contain, retain, and provide information regarding other nodes and data.

The SPP™ Components

The SPP™ component 635 is a stored program component that is executed by a CPU. In one embodiment, the SPP™ component incorporates any and/or all combinations of the aspects of the SPP™ systems discussed in the previous figures. As such, the SPP™ component affects accessing, obtaining and the provision of information, services, transactions, and/or the like across various communications networks.

The SPP™ component may transform data collected by the solar power plant or input signals received, e.g., from a mobile device, into commands for operating the solar power plant.

The SPP™ component enabling access of information between nodes may be developed by employing standard development tools and languages such as, but not limited to: Apache components, Assembly, ActiveX, binary executables, (ANSI) (Objective-) C (++), C #and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the SPP™ server employs a cryptographic server to encrypt and decrypt communications. The SPP™ component may communicate to and/or with other components in a component collection, including itself, and/or facilities of the like. Most frequently, the SPP™ component communicates with the SPP™ database, operating systems, other program components, and/or the like. The SPP™ may contain, communicate, generate, obtain, and/or provide program component, system, user, and/or data communications, requests, and/or responses.

Distributed SPP™ Embodiments

The structure and/or operation of any of the SPP™ node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the SPP™ controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

In order to address various issues and advance the art, the entirety of this application shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all disclosed embodiments. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

All statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Descriptions herein of circuitry and method steps and computer programs represent conceptual embodiments of illustrative circuitry and software embodying the principles of the disclosed embodiments. Thus the functions of the various elements shown and described herein may be provided through the use of dedicated hardware as well as hardware capable of executing software in association with appropriate software as set forth herein.

Terms to exemplify orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

In the disclosure hereof any element expressed as a means for performing a specified function is intended to encompass any way of performing that function including, for example, a) a combination of circuit elements and associated hardware which perform that function or b) software in any form, including, therefore, firmware, microcode or the like as set forth herein, combined with appropriate circuitry for executing that software to perform the function. Applicants thus regard any means which can provide those functionalities as equivalent to those shown herein.

Similarly, it will be appreciated that the system and process flows described herein represent various processes which may be substantially represented in computer-readable media and so executed by a computer or processor, whether or not such computer or processor is explicitly shown. Moreover, the various processes can be understood as representing not only processing and/or other functions but, alternatively, as blocks of program code that carry out such processing or functions.

As examples, the Specification describes and/or illustrates aspects useful for implementing the claimed disclosure by way of various circuits or circuitry which may be illustrated as or using terms such as blocks, modules, device, system, unit, controller, and/or other circuit-type depictions. Such circuits or circuitry are used together with other elements to exemplify how certain embodiments may be carried out in the form or structures, steps, functions, operations, activities, etc. In certain embodiments, such illustrated items represent one or more computer circuitry (e.g., microcomputer or other CPU) which is understood to include memory circuitry that stores code (program to be executed as a set/sets of instructions) for performing an algorithm. The specification may also make reference to an adjective that does not connote any attribute of the structure (“first [type of structure]” and “second [type of structure]”) in which case the adjective is merely used for English-language antecedence to differentiate one such similarly-named structure from another similarly-named structure (e.g., “first circuit configured to convert . . . ” is interpreted as “circuit configured to convert . . . ”). On the other hand, specification may make reference to an adjective that is intended to connote an attribute of the structure (e.g., monitor server), in which case the adjective (e.g., monitor) modifies to refer to at least a portion of the named structure (e.g., server) is configured to have/perform that attribute (e.g., monitor server refers to at least a portion of a server that includes/performs the attribute of monitoring.

The methods, systems, computer programs and mobile devices of the present disclosure, as described above and shown in the drawings, among other things, provide for improved solar power production methods, systems and machine readable programs for carrying out the same. It will be apparent to those skilled in the art that various modifications and variations can be made in the devices, methods, software programs and mobile devices of the present disclosure without departing from the spirit or scope of the disclosure. Thus, it is intended that the present disclosure include modifications and variations that are within the scope of the subject disclosure and equivalents.

What is claimed is:

1. A portable solar power plant, comprising:
a chassis; and
a plurality of arranged deployable solar panels, each of the plurality of deployable solar panels being slidably disposed on a respective horizontal track coupled to the chassis.

2. The portable solar power plant of claim 1, wherein:
the plurality of solar panels are disposed in a stacked horizontal configuration in an undeployed configuration; and
each of the plurality of solar panels is configured to deploy horizontally outwardly into a deployed configuration.

3. The portable solar power plant of claim 2, wherein each solar panel in the plurality of solar panels does not substantially obscure another of said solar panels in the deployed configuration from incident sunlight.

4. The portable solar power plant of claim 2, wherein:
a first solar panel in the plurality of solar panels is disposed above a second solar panel in the plurality of solar panels; and
the first solar panel in the plurality of solar panels includes a downwardly depending wiper extending toward an upper surface of the second solar panel in the plurality of solar panels; and
the wiper wipes across and cleans at least a portion of the upper surface of the second solar panel in the plurality of solar panels when the solar panels are deployed.

5. The portable solar power plant of claim 4, wherein the wiper includes one or more of (i) a brush, (ii) a fabric material, and (iii) a material that electrostatically attracts dust particulate.

6. The portable solar power plant of claim 2, further comprising a container including first and second side walls extending between first and second ends of the container, the first and second side walls being connected by a top wall and a bottom wall, wherein the chassis is coupled to the container.

7. The portable solar power plant of claim 6, wherein the plurality of solar panels are disposed in a stacked horizontal configuration in an undeployed configuration inside of the container.

8. The portable solar power plant of claim 7, wherein the plurality of solar panels are arranged in first and second deployable banks of solar panels, wherein the first deployable bank of solar panels is configured to deploy outwardly along a first horizontal direction, and further wherein the second deployable bank of solar panels is configured to deploy outwardly along a second horizontal direction opposite to the first horizontal direction.

9. The portable solar power plant of claim 8, wherein the first deployable bank of solar panels is configured to deploy outwardly through an opening defined in the first side of the container and the second deployable bank of solar panels is configured to deploy outwardly through an opening defined in the second side of the container.

10. The portable solar power plant of claim 8, wherein the first deployable bank of solar panels is disposed above the second deployable bank of solar panels when the solar panels are in the undeployed configuration inside of the container.

11. The portable solar power plant of claim 10, wherein the first deployable bank of solar panels deploys outwardly from the container at a higher elevation than the second deployable bank of solar panels.

12. The portable solar power plant of claim 10, wherein each solar panel in the first deployable bank of solar panels is more than half of a width of the container.

13. The portable solar power plant of claim 10, wherein the first and second banks of solar panels are located upwardly from the bottom wall of the container to define a lower compartment within the container that includes circuitry for operating the portable solar power plant.

14. The portable solar power plant of claim 6, further comprising an upper bank of solar panels disposed above the top wall of the container when the upper bank of solar panels is in a deployed configuration.

15. The portable solar power plant of claim 14, wherein the upper bank of solar panels extends beyond the first and second ends of the container when the upper bank of solar panels is in a deployed configuration.

16. The portable solar power plant of claim 6, further comprising a plurality of adjustable vertical supports beneath the bottom of the container to support and level the container.

17. The portable solar power plant of claim 8, further comprising a controller operably coupled to the solar panels, the controller being configured to direct electrical power generated by the solar panels.

18. The portable solar power plant of claim 17, wherein the controller is operably coupled to a drive to selectively deploy and collapse the first and second deployable banks of solar panels in response to an input to the controller.

19. The portable solar power plant of claim 18, wherein the drive is selected from (i) a hydraulic drive, (ii) a pneumatic drive, and (iii) a drive driven by an electric motor.

20. The portable solar power plant of claim 17, wherein the controller is programmed to perform a cleaning procedure on at least some of the solar panels.

21. A portable solar power plant, comprising:
a portable frame; and
a plurality of deployable solar panels folded about the portable frame in an undeployed stored configuration, each of the plurality of deployable solar panels being coupled to the portable frame by at least one hinged connection, each of the plurality of deployable solar panels being deployable about the at least one hinged connection from the undeployed configuration into a deployed configuration.

22. The portable solar power plant of claim 21, wherein the portable frame has a length and a width, wherein hinged connections about which each of the plurality of deployable solar panels deploys are parallel to the length or the width of the portable frame.

23. The portable solar power plant of claim 22, wherein the plurality of deployable solar panels are formed into a plurality of deployable banks of deployable solar panels.

24. The portable solar power plant of claim 23, wherein a first of the plurality of deployable banks of deployable solar panels is collapsed around a first lateral side of the portable frame when in the undeployed configuration.

25. The portable solar power plant of claim 24, wherein a second of the plurality of deployable banks of deployable solar panels is collapsed around a second lateral side of the portable frame when in the undeployed configuration.

26. The portable solar power plant of claim 25, wherein a third of the plurality of deployable banks of deployable solar panels is collapsed around an upper side of the portable frame when in the undeployed configuration.

27. The portable solar power plant of claim 26, wherein the first, second and third deployable banks of deployable solar panels are configured to deploy into a flat array.

28. The portable solar power plant of claim 26, wherein the flat array is mounted on a main hinged connection with respect to the portable frame to permit the flat array to rotate from a first position to a second position about the main hinged connection.

29. The portable solar power plant of claim 28, further comprising a controller operably coupled to the solar panels, the controller being configured to direct electrical power generated by the solar panels.

30. The portable solar power plant of claim 29, wherein the controller is operably coupled to a drive to selectively position the array deploy and collapse the first and second deployable banks of solar panels in response to an input to the controller.

31. The portable solar power plant of claim 21, wherein the portable frame includes a horizontally extending portion and a vertically extending portion coupled to the horizontally extending portion.

32. The portable solar power plant of claim 31, wherein the plurality of solar panels are pivotally connected to the vertically extending portion of the frame.

33. The portable solar power plant of claim 32, wherein the horizontally extending portion of the portable frame includes at least one pair of wheels to transport the portable solar power plant.

34. The portable solar power plant of claim 33, wherein the horizontally extending portion of the portable frame includes at least one coupling to attach to a tow vehicle to transport the portable solar power plant.

35. A method of generating electricity, comprising:
providing the portable solar power plant of claim 21;
unfolding the plurality of deployable solar panels folded about the portable frame by pivoting the plurality of deployable solar panels about a first set of hinges to partially deploy the solar panels in a first deployment step; and
further unfolding the plurality of deployable solar panels about a second set of hinges oriented orthogonally with respect to the first set of hinges to form a planar solar array in a second deployment step.

36. The method of claim 35, wherein at least two solar panels in the plurality of deployable solar panels have photoactive surfaces facing each other prior to deploying the solar panels.

37. A portable solar power plant, comprising:
a shipping container;
electronics to operate the portable solar power plant disposed within the container; and
a plurality of solar panels removably coupled to the container with fasteners, wherein the shipping container is sized to contain the plurality of solar panels and electronics to operate the portable solar power plant to permit all components of the portable solar power plant to fit inside the container to facilitate shipment prior to deploying the portable solar power plant.

38. The portable solar power plant of claim 37, further comprising a plurality of removable legs coupled to the shipping container.

39. A method, comprising providing a kit to assemble the portable solar power plant of claim 37, wherein all components of the portable solar power plant are disposed within the shipping container; shipping the kit to an end location; and assembling the portable solar power plant.
